(19) United States
(12) Patent Application Publication
(10) Pub. No.: US 2025/0338044 A1
(43) Pub. Date: Oct. 30, 2025

(54) CONVERSION APPARATUS, METHOD FOR THE CONVERSION APPARATUS, AND EQUIPMENT

(71) Applicant: CANON KABUSHIKI KAISHA, Tokyo (JP)

(72) Inventors: AOI MORISHITA, Kanagawa (JP); TATSUYA RYOKI, Kanagawa (JP); TAKANORI YAMASHITA, Tokyo (JP); SATOSHI KUMAKI, Saitama (JP); HIDEKI IKEDO, Kanagawa (JP)

(21) Appl. No.: 19/191,979

(22) Filed: Apr. 28, 2025

(30) Foreign Application Priority Data
Apr. 30, 2024 (JP) 2024-074089

(51) Int. Cl. H04N 25/78; B60W 30/09; H04N 25/709; H04N 25/77

(52) U.S. Cl. CPC H04N 25/78; B60W 30/09; H04N 25/709; H04N 25/77; B60W 2420/403

(57) ABSTRACT

A method for a conversion apparatus including a pixel which generates a pixel signal, an output line, and a comparator including first and second input nodes for respectively inputting a reference signal and the pixel signal via the output line, includes causing a voltage of the second input node to change from a second voltage to a first voltage and then from the first voltage to a third voltage during a comparator reset period, causing the voltage to change in a first direction when the pixel signal is input to the second input node, and setting a direction in which the voltage changes from the second voltage to the first voltage to be different from the first direction and setting a direction in which the voltage of the second input node changes from the first voltage to the third voltage to be the same as the first direction.

### BACKGROUND

### Technical Field

The aspect of the embodiments relates to a conversion apparatus, a method for the conversion apparatus, and an equipment.

### Description of the Related Art

Japanese Patent Laid-Open No. 2023-111095 describes a photoelectric conversion apparatus including an analog-to-digital (AD) conversion circuit configured to convert a pixel signal output from a pixel into a digital signal. In a configuration described in Japanese Patent Laid-Open No. 2023-111095, pixel signals output from a plurality of pixels arranged in different rows are sequentially subjected to AD conversion by row by using the AD conversion circuit.

However, in the configuration described in Japanese Patent Laid-Open No. 2023-111095, under an influence of the AD conversion of the pixel signal output from the pixel arranged in a certain row, an accuracy of the AD conversion of the pixel signal output from the pixel arranged in a row different from the certain row may degrade. The above-described aspect has not been taken into account in Japanese Patent Laid-Open No. 2023-111095.

### SUMMARY

According to an aspect of the embodiments, there is provided a method for a conversion apparatus including a pixel configured to generate a pixel signal through photoelectric conversion, an output line connectable to the pixel, and a comparator including a first input node to which a reference signal is input and a second input node to which the pixel signal is input via the output line, the method including causing a voltage of the second input node to change from a second voltage to a first voltage and thereafter to change from the first voltage to a third voltage during a reset period of the comparator, causing the voltage of the second input node to change in a first direction in a case where the pixel signal is input to the second input node, and setting a direction in which the voltage of the second input node changes from the second voltage to the first voltage to be different from the first direction and setting a direction in which the voltage of the second input node changes from the first voltage to the third voltage to be the same as the first direction.

Further features of the disclosure will become apparent from the following description of exemplary embodiments with reference to the attached drawings.

### BRIEF DESCRIPTION OF THE DRAWINGS

FIG. 1 is a block diagram for describing a photoelectric conversion apparatus according to a first embodiment.

FIG. 2 is a circuit diagram for describing the photoelectric conversion apparatus according to the first embodiment.

FIG. 3 is a circuit diagram for describing the photoelectric conversion apparatus according to the first embodiment.

FIG. 4 is a circuit diagram for describing the photoelectric conversion apparatus according to the first embodiment.

FIG. 5 is a drive timing chart for describing the photoelectric conversion apparatus according to a reference example.

FIG. 6 is a drive timing chart for describing the photoelectric conversion apparatus according to the reference example.

FIG. 7 is a drive timing chart for describing the photoelectric conversion apparatus according to the first embodiment.

FIG. 8 is a circuit diagram for describing the photoelectric conversion apparatus according to a second embodiment.

FIG. 9 is a drive timing chart for describing the photoelectric conversion apparatus according to the second embodiment.

FIG. 10 is a circuit diagram for describing the photoelectric conversion apparatus according to a third embodiment.

FIG. 11 is a drive timing chart for describing the photoelectric conversion apparatus according to the third embodiment.

FIG. 12 is a circuit diagram for describing the photoelectric conversion apparatus according to a fourth embodiment.

FIG. 13 is a circuit diagram for describing the photoelectric conversion apparatus according to a fifth embodiment.

FIG. 14 is a circuit diagram for describing the photoelectric conversion apparatus according to the fifth embodiment.

FIG. 15 is a drive timing chart for describing the photoelectric conversion apparatus according to the fifth embodiment.

FIG. 16A, FIG. 16B, and FIG. 16C are schematic diagrams for describing an equipment according to a sixth embodiment.

### DESCRIPTION OF THE EMBODIMENTS

Hereinafter, each of embodiments will be described with reference to the drawings. It is noted that each of the following embodiments is not limited to the invention according to the claims. A plurality of features are described in the embodiments, but not all combinations of the plurality of these features are used as solutions in the disclosure, and multiple features may be optionally combined. Furthermore, in the accompanying drawings, the same reference sign is assigned to the same or similar component, and the redundant description will be omitted. In addition, according to each of the embodiments described below, as an example of a photoelectric conversion apparatus, a sensor for image sensing will be mainly described. It is noted however that each of the embodiments is not limited to the sensor for image sensing and can be applied to other examples of the photoelectric conversion apparatus. For example, the other examples include an image sensing apparatus, a distance measuring apparatus (apparatus for distance measurement or the like using focus detection or time of flight (TOF)), a light metering apparatus (apparatus for measurement of an amount of incident light or the like), and the like.

In the present specification, terms that indicate specific directions or positions (for example, “up”, “down”, “right”, and “left”, and other terms that incorporate these terms) are used when necessary. The use of these terms is for a purpose for ease of understanding the embodiments with reference to the drawings, and a technical scope of the disclosure is not limited by the meanings of those terms.

In the present specification, in a case where a phrase “electrically connecting a member A to a member B” is stated, the phrase is not limited to a case where the member A and the member B are directly connected to each other”. For example, even when another member C is connected between the member A and the member B, it is sufficient when the member A and the member B are electrically connected to each other.

In the present specification, a “plane” refers to a surface parallel to a main surface of a substrate. The main surface of the substrate may be a light incidence surface of a substrate which includes a photoelectric conversion element, a surface on which a plurality of ADCs are repeatedly arranged, or a bonding surface between substrates in a lamination type photoelectric conversion apparatus. In addition, a “planar view” refers to a view seen from a direction perpendicular to the main surface of the substrate. Furthermore, a “cross section” refers to a surface in a direction perpendicular to a light incidence surface of a semiconductor layer. In addition, a “cross sectional view” refers to a view seen from a direction parallel to the main surface of the substrate.

A metallic member such as a wiring or a pad described in the present specification may be made of an elemental metal of one certain element or made of a mixture (alloy). For example, a wiring described as a copper wiring may be made of copper as an element or may have a composition which mainly contains copper and further contains other ingredients. In addition, for example, a pad connected to an external terminal may be made of aluminum as an element or may have a composition which mainly contains aluminum and further contains other ingredients. The copper wiring and the aluminum pad illustrated herein are examples and can be changed to be made of various metals. In addition, the wiring and the pad illustrated herein are examples of metallic members to be used in the photoelectric conversion apparatus and may also be applicable to other metallic members.

A relationship with regard to “substantially equal” and “substantially identical” in the disclosure will be described. Although the relationship is assumed to be equal in design, slight differences may be caused due to a manufacturing error. The slight differences caused by this manufacturing error are accommodated in this “substantially equal” or “substantially identical”.

### First Embodiment

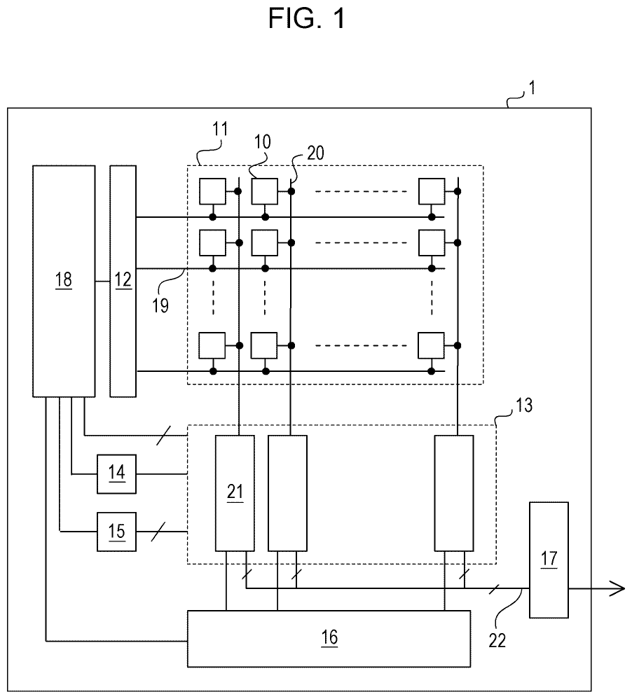

A photoelectric conversion apparatus according to a first embodiment of the disclosure will be described with reference to FIG. 1 to FIG. 4 and FIG. 7.

FIG. 1 is an example of a block diagram of a photoelectric conversion apparatus 1 according to the present embodiment.

As illustrated in FIG. 1, the photoelectric conversion apparatus 1 includes a pixel array 11, a row selection circuit 12, a signal processing circuit 13, a reference signal output circuit 14, a counter circuit 15, a column selection circuit 16, an output circuit 17, and a control circuit 18. The photoelectric conversion apparatus 1 also includes a control line 19, a vertical output line 20, and a horizontal output line 22.

The pixel array 11 includes a plurality of pixels 10 configured to perform photoelectric conversion, and the plurality of pixels 10 are provided across a plurality of rows and a plurality of columns in the pixel array 11. The pixel 10 generates a pixel signal through the photoelectric conversion. It is noted that the pixel signal output from the pixel 10 is an analog signal. It is noted that in the present specification, a horizontal direction in the drawings is described as a row direction, and a vertical direction is described as a column direction. The number of rows and the number of columns arranged in the pixel array 11 are not particularly limited. The plurality of pixels 10 may include, in addition to an effective pixel configured to output a pixel signal according to an amount of incident light, an optical black pixel where the photoelectric conversion element is light-shielded, a dummy pixel from which a signal is not output, and the like.

A plurality of control lines 19 extending in the row direction are arranged in each row of the pixel array 11. Each of the plurality of control lines 19 is electrically connected to the plurality of corresponding pixels 10 aligned in the row direction. One control line 19 commonly controls the plurality of pixels 10 arranged in one row. The row selection circuit 12 includes a shift register, a gate circuit, a buffer circuit, or the like. The row selection circuit 12 outputs a control signal based on a vertical synchronizing signal, a horizontal synchronizing signal, a clock signal, or the like to the pixel array 11 to drive the plurality of pixels 10 by row.

A plurality of vertical output lines extending in the column direction are arranged in each column of the pixel array 11. Each of the plurality of vertical output lines 20 is electrically connected to the plurality of corresponding pixels 10 aligned in the column direction. The plurality of pixels 10 arranged in each column are electrically connected to the signal processing circuit 13 via each of the plurality of vertical output lines 20, and the pixel signals output from the plurality of pixels 10 are input to the signal processing circuit 13 on a row-by-row basis. The signal processing circuit 13 includes a plurality of analog-to-digital (AD) conversion circuits 21 corresponding to respective pixel columns in which the plurality of pixels 10 are arranged. The AD conversion circuit 21 implements signal processing such as AD conversion processing on the pixel signals read from the pixels 10 arranged in the corresponding column. In the present embodiment, a slope type AD conversion will be described as an AD conversion method, but an AD conversion method other than the slope type AD conversion, such as a successive approximation type AD conversion or a 42 type AD conversion, may be adopted. It is noted that the number of vertical output lines 20 arranged for the plurality of pixels 10 arranged in one column is not limited to one, and a plurality of vertical output lines 20 may be arranged. In the above-described case, the AD conversion circuits 21 corresponding to the vertical output lines 20 are to be used. In a case where the plurality of vertical output lines 20 are prepared for one column, since the plurality of pixels 10 arranged in the plurality of rows can be read out at the same timing, a high speed readout operation of the pixel signals is enabled.

In addition, the reference signal output circuit 14 outputs a reference signal that is a signal in which a voltage changes along with an elapse of time. The AD conversion circuit 21 performs AD conversion by using the reference signal on the pixel signal that is an analog signal to be output as a digital signal. It is noted that the reference signal output circuit 14 may generate the reference signal, or a circuit different from the reference signal output circuit 14 may generate the reference signal. For example, the reference signal may be generated by using various methods such as a capacitive charging method, a DAC method, and a current steering method. The reference signal having a constant gradient (amount of change in the voltage per unit time) is used in the present embodiment, but the reference signal in which the gradient changes along the way may be used. The reference signal in which the gradient changes along the way also includes a case, for example, where the gradient changes stepwise.

The counter circuit 15 outputs a count signal CNT to be used for the AD conversion performed in the signal processing circuit 13. The count signal CNT is a signal for counting a clock pulse signal CLK supplied from a clock pulse supply circuit which is not illustrated in the drawing in synchronization with a timing at which the reference signal of the reference signal output circuit 14 starts to change in a time-dependent manner. It is noted that the counter circuit 15 illustrated in FIG. 1 is commonly provided for the plurality of AD conversion circuits 21 but may be provided so as to correspond to each of the plurality of AD conversion circuits 21.

The column selection circuit 16 includes a logic circuit such as a shift register or an address decoder. The column selection circuit 16 selects a column in which the pixels 10 are arranged. The pixel signals after the AD conversion corresponding to the column selected by the column selection circuit 16 are sequentially output to the outside of the photoelectric conversion apparatus via the horizontal output line 22 and the output circuit 17.

In addition, the output circuit 17 includes a buffer amplifier, a differential amplifier, or the like and implements predetermined signal processing on the pixel signals output from the pixels 10 in the column selected by the column selection circuit 16 to output the pixel signals after the processing. Examples of the signal processing performed by the output circuit 17 include, for example, correction processing by correlated double sampling (CDS), amplification processing, and the like. In addition, the output circuit 17 includes a serial output circuit of a low voltage differential signal (LVDS) method and outputs the digital signals on which the signal processing has been performed to the outside of the photoelectric conversion apparatus at a high speed with low power consumption. It is noted that the output method is not limited to LVDS, and other methods may be adopted.

The control circuit 18 supplies control signals to the row selection circuit 12, the signal processing circuit 13, the reference signal output circuit 14, the counter circuit 15, and the column selection circuit 16.

It is noted that FIG. 1 illustrates an example in which one circuit block is provided which is configured to read out pixel signals and includes the signal processing circuit 13, the column selection circuit 16, and the output circuit 17. However, a plurality of circuit blocks configured to read out the pixel signals may be provided while the pixel array 11 is placed in between. In the above-described case, for example, the pixel signals from the pixels 10 arranged in an even numbered column are input to one of the circuit blocks, and the pixel signals from the pixel 10 arranged in an odd numbered column are input to another one of the circuit blocks, so that the high speed readout of the pixel signals is enabled.

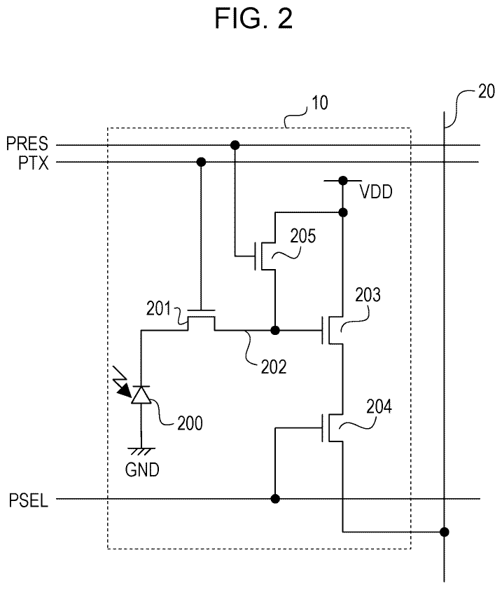

FIG. 2 is an example of a circuit diagram of the pixel 10 included in the photoelectric conversion apparatus 1 according to the present embodiment. It is noted that the present disclosure can be applied to any sensors of a front surface irradiation type and a rear surface irradiation type.

As illustrated in FIG. 2, the pixel 10 includes a photoelectric conversion element 200, a transfer transistor 201, and a floating diffusion 202. Hereinafter, in the present specification, the floating diffusion 202 may be described as an FD 202 (FD is an abbreviation for floating diffusion). In addition, the FD 202 may be described as a floating diffusion region 202.

The pixel 10 further includes a reset transistor 205 configured to reset the FD 202, an amplification transistor 203 configured to amplify a signal, and a selection transistor 204. The photoelectric conversion element 200 is electrically connected to a ground voltage node GND and supplied with a ground voltage. In addition, the reset transistor 205 and the amplification transistor 203 are electrically connected to a power source voltage node VDD and supplied with a power source voltage.

It is noted that each of the transfer transistor 201, the reset transistor 205, the amplification transistor 203, and the selection transistor 204 may be a MOS transistor of an N type or a MOS transistor of a P type. According to the present embodiment, a case will be described where of electron-hole pairs that are generated in the photoelectric conversion element 200 through light incidence, electrons are used as signal charges. In a case where electrons are used as the signal charges, each of the transistors included in the pixel 10 may be constituted as a MOS transistor of the N type. It is noted however that the signal charges are not limited to electrons, and holes may be used as the signal charges. In a case where holes are used as the signal charges, each of the transistors included in the pixel 10 may be constituted by a MOS transistor of the P type that is different from a transistor described in the present embodiment.

The photoelectric conversion element 200 is, for example, a photodiode. The photoelectric conversion element 200 is not limited to the photodiode and may be, for example, a photoelectric conversion film. The photoelectric conversion element 200 receives light incident on the pixel 10 and generates charges according to the incident light to accumulate the charges. The reset transistor 205 is driven by a control signal PRES. When the reset transistor 205 turns on (to be put into a conductive state), the FD 202 is reset to a voltage based on the power source voltage. Then, when the reset transistor 205 turns off (to be put into a non-conductive state), the reset of the FD 202 is cancelled. The transfer transistor 201 is driven by a control signal PTX. When the transfer transistor 201 turns on, the charges generated in the photoelectric conversion element 200 are transferred to the FD 202. The FD 202 functions as a charge-to-voltage conversion unit configured to temporarily hold charges input from the photoelectric conversion element 200 and convert the held charges into a voltage signal. The amplification transistor 203 amplifies the pixel signal (voltage signal) converted in the FD 202. The selection transistor 204 is driven by a control signal PSEL. The selection transistor 204 connects the amplification transistor 203 to the vertical output line 20 and outputs the pixel signal amplified by the amplification transistor 203 to the vertical output line 20. It is noted that the pixel signal may include a signal (noise signal) at a reset level of the FD 202 and a signal (photoelectric conversion signal) output from the photoelectric conversion element 200. The noise signal is a signal mainly containing noise components included in the pixel 10.

It is noted that the configuration of the pixel 10 illustrated in FIG. 2 is an example, and the pixel 10 may further include a transistor. For example, the pixel 10 may further include a transistor configured to change a capacitance value of the FD 202 or a transistor configured to discharge the charges from the photoelectric conversion element 200. In addition, a configuration may be adopted in which the pixel 10 does not include the selection transistor 204, and selection and non-selection states of the pixel 10 are changed depending on a voltage input from the reset transistor 205 to the FD 202.

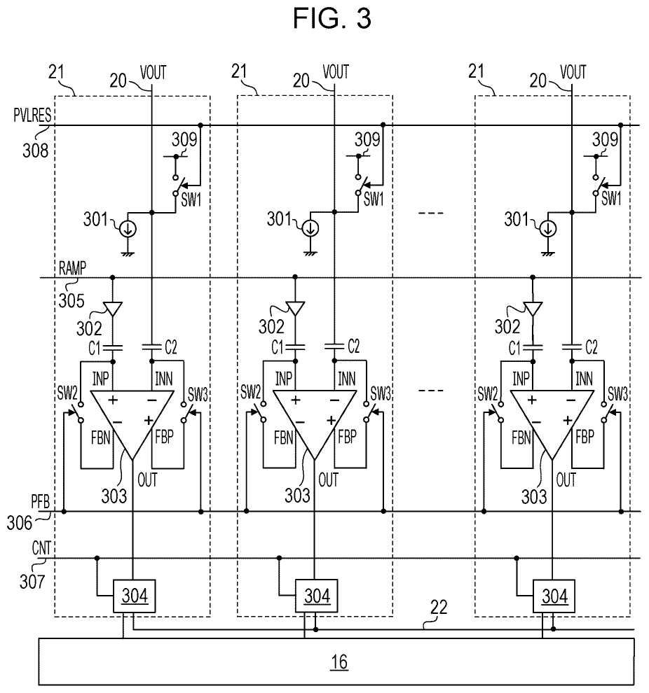

FIG. 3 is an example of a circuit diagram of the AD conversion circuit 21 included in the photoelectric conversion apparatus 1 according to the present embodiment.

As illustrated in FIG. 3, the AD conversion circuit 21 includes a current source 301, a first buffer circuit 302, a comparator 303, and a memory circuit 304. In addition, the AD conversion circuit 21 includes a first capacitor element C1, a second capacitor element C2, a first switch SW1, a second switch SW2, and a third switch SW3. It is noted that in the present specification, a voltage of the vertical output line 20 may be denoted as VOUT. The voltage VOUT may vary since the pixel signal is input from the pixel 10 to the vertical output line 20. It is noted that in the present specification, the reference signal may be denoted as RAMP, and a voltage of the reference signal may be denoted as VRAMP.

The comparator 303 is constituted by a differential amplifier circuit, for example. The comparator 303 includes a first input node INP serving as a non-inverting input terminal, a second input node INN serving as an inverting input terminal, a first output node FBN serving as an inverting output terminal, and a second output node FBP serving as a non-inverting output terminal in the differential stage. In addition, the comparator 303 includes a third output node OUT serving as an output terminal in the amplification stage. It is noted that the comparator 303 may implement an offset clamp operation based on a voltage of the pixel signal and the voltage of the reference signal.

The second switch SW2 is electrically connected to the first input node INP and the first output node FBN and arranged between the first input node INP and the first output node FBN. The third switch SW3 is electrically connected to the second input node INN and the second output node FBP and arranged between the second input node INN and the second output node FBP. The second switch SW2 and the third switch SW3 are switches controlled by a control signal PFB supplied from the control circuit 18 via a feedback signal line 306. The second switch SW2 and the third switch SW3 are switches configured to reset a threshold voltage of the comparator 303.

The first buffer circuit 302 includes an input node and an output node. The input node of the first buffer circuit 302 is supplied with the reference signal from the reference signal output circuit 14 via a reference signal line 305. The output node of the first buffer circuit 302 is electrically connected to the first input node INP via the first capacitor element C1. That is, the reference signal output from the reference signal output circuit 14 is input to the first input node INP via the reference signal line 305, the first buffer circuit 302, and the first capacitor element C1.

The vertical output line 20 is electrically connected to the second input node INN via the second capacitor element C2. The pixel signal output from the pixel 10 is input to the second input node INN of the comparator 303 via the vertical output line 20 and the second capacitor element C2. In addition, the vertical output line 20 is electrically connected to the current source 301. The current source 301 has a role as a load current source of the amplification transistor 203 of the pixel 10. The first switch SW1 includes a first node electrically connected to a first voltage node 309 and a second node electrically connected to the vertical output line 20.

That is, the vertical output line 20 can be electrically connected to the first voltage node 309 via the first switch SW1. The first switch SW1 is a switch controlled by a control signal PVLRES supplied from the control circuit 18 via a first switch control line 308. When the control signal PVLRES turns to the high level, the vertical output line 20 is electrically connected to the first voltage node 309. Note that it is sufficient when the first voltage node 309 is supplied with a voltage that is greater than or equal to a predetermined value (first voltage). For example, the first voltage node 309 may be supplied with the power source voltage that is supplied to the power source voltage node VDD.

The comparator 303 outputs, to the memory circuit 304, a comparison result signal COUT indicating a result of a comparison between the pixel signal input via the vertical output line 20 and the reference signal. For example, the comparator 303 outputs a low level when the voltage of the reference signal is higher than the voltage of the pixel signal (when a signal amplitude of the reference signal is smaller than that of the pixel signal). The comparator 303 outputs a high level when the voltage of the reference signal is lower than the voltage of the pixel signal (when the signal amplitude of the reference signal is larger than that of the pixel signal). It is noted that a relationship between the high level and the low level at this time is an example and may be a reversed relationship. The memory circuit 304 holds the count signal CNT input from the counter circuit 15 illustrated in FIG. 1 via a count signal line 307 based on a change in a value of the comparison result signal COUT output from the comparator 303. With this configuration, the count signal CNT with a signal value corresponding to a value of the pixel signal is held in the memory circuit 304 as a digital signal corresponding to the pixel signal, and the pixel signal output from the pixel 10 is subjected to the AD conversion. The digital signals held in the memory circuit 304 are sequentially transferred by column to the output circuit 17 via the horizontal output line 22 according to control signals supplied from the column selection circuit 16.

According to the present embodiment, all of the above-described circuit blocks may be arranged on a single substrate, or the plurality of these circuit blocks may be separately arranged on respective substrates in a stacked type structure with multiple stacked substrates.

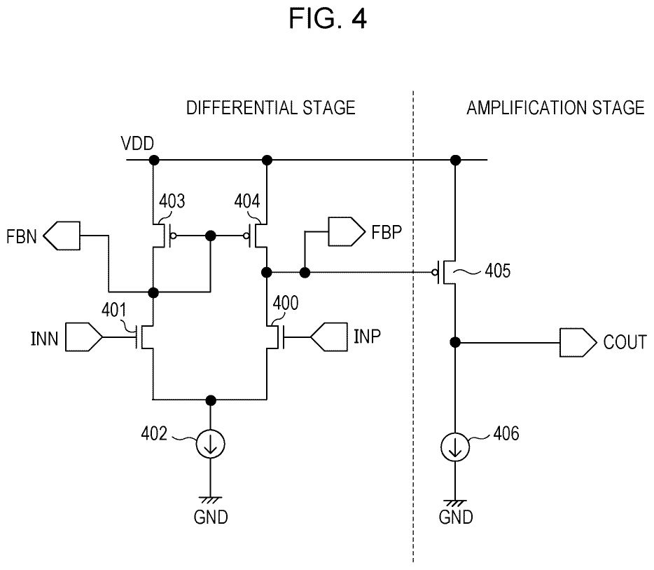

FIG. 4 is an example of a circuit diagram of the comparator 303 included in the AD conversion circuit 21 according to the present embodiment.

As illustrated in FIG. 4, the comparator 303 includes a differential stage and an amplification stage. In the differential stage, a first input transistor 400, a second input transistor 401, a first current source 402, a first current mirror transistor 403, and a second current mirror transistor 404 are arranged. The first input transistor 400 is arranged so as to correspond to the first input node INP, and the second input transistor 401 is arranged so as to correspond to the second input node INN. In the amplification stage, a third input transistor 405 and a second current source 406 are arranged.

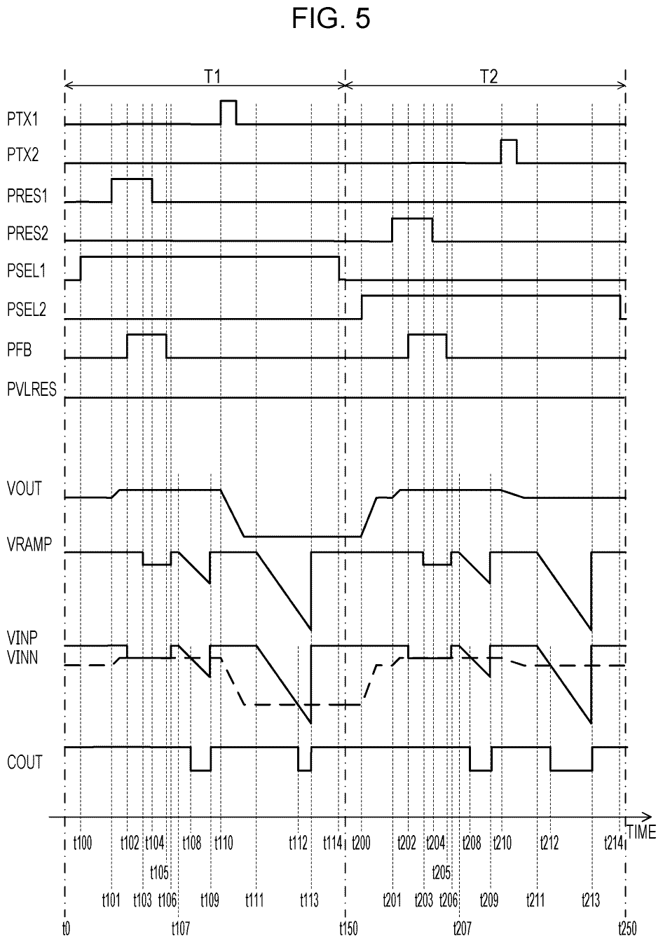

FIG. 5 is an example of a drive timing chart of the photoelectric conversion apparatus 1 according to a reference example. In FIG. 5, a horizontal axis represents time, and a vertical axis represents a voltage. In addition, FIG. 5 schematically illustrates the voltage of each of the control signals (timing of each of the drive pulses), the voltage VOUT, the voltage VRAMP, a voltage VINP at the first input node INP, and a voltage VINN at the second input node INN. It is noted that while the voltage VINP is represented by a solid line, the voltage VINN is represented by a broken line. It is noted that each of the control signals illustrated in FIG. 5 corresponds to each of the control signals illustrated in FIG. 2 and FIG. 3. It is noted that in a case where the control signal is at the high level, each of the corresponding transistors and each of the corresponding switches are put into the on state, and in a case where the control signal is at the low level, each of the corresponding transistors and each of the corresponding switches are put into the off state.

FIG. 5 illustrates timings in a case where the pixel signals are read out from the pixels 10 arranged in any two of successively reading-out rows (hereinafter, described as a first row and a second row). It is noted that a period T1 indicates a readout period of the pixel signals output from the pixels 10 (first pixels 10-1) arranged in the first row, and a period T2 indicates a readout period of the pixel signals output from the pixels 10 (second pixels 10-2) arranged in the second row. The control signals PTX1, PRES1, and PSEL1 are controls signals which are output to the first pixels 10-1, and the control signals PTX2, PRES2, and PSEL2 are controls signals which are output to the second pixels 10-2. Herein, for example, it is assumed that the amount of light incident on the first pixel 10-1 is higher than the amount of light incident on the second pixel 10-2.

At a point in time t100, the control signal PSEL1 turns to the high level from the low level, and the selection transistor 204 of the first pixel 10-1 turns on. Then, the first row is selected as a row from which the pixel signals are to be output.

During a period from a point in time t101 to a point in time t104, the control signal PRES1 turns to the high level, and the reset transistor 205 of the first pixel 10-1 turns on. Then, the first pixel 10-1 outputs the noise signal as the pixel signal to the vertical output line 20 arranged in the corresponding column.

During a period from a point in time t102 to a point in time t105, the control signal PFB turns to the high level, and the second switch SW2 and the third switch SW3 turn on. Then, the first input node INP and the second input node INN of the comparator 303 are reset to the voltage at the reset level. It is noted that at a point in time t103, the voltage VRAMP turns to a reference voltage, and an offset removal operation is performed.

That is, at the point in time t105, a node of the second capacitor element C2 on the first pixel 10-1 side is set to the voltage at the reset level of the FD 202, and a node of the second capacitor element C2 on the comparator 303 side is set to the voltage at the reset level of the comparator 303. In addition, a node of the first capacitor element C1 on the reference signal output circuit 14 side is set to the reference voltage of the reference signal, and a node of the first capacitor element C1 on the comparator 303 side is set to the voltage at the reset level of the comparator 303. Thus, the threshold voltage of the comparator 303 is reset to a voltage equivalent to a difference between the voltage at the reset level of the FD 202 (voltage of the noise signal) and the reference voltage of the reference signal. It is noted that the threshold voltage of the comparator 303 is a voltage equivalent to a difference between the voltage VOUT and the voltage VRAMP when the value of the comparison result signal COUT output from the comparator 303 changes. That is, the value of the comparison result signal COUT output from the comparator 303 changes before and after a timing at which the difference between the voltage VOUT and the voltage VRAMP becomes equivalent to the above-described voltage that has been reset. Therefore, the comparator 303 outputs the comparison result signal COUT which indicates different values depending on a case where the difference between the voltage VOUT and the voltage VRAMP is lower than the threshold voltage and a case where the difference is higher than the threshold voltage.

At a point in time t106, the voltage VRAMP increases to a predetermined start voltage from the reference voltage.

Next, during a period from a point in time t107 to a point in time t109, the voltage VRAMP decreases the start voltage in a time-dependent manner. In addition, at the point in time t107, the voltage VRAMP changes, and also the counter circuit 15 starts counting of clock pulse signals and supplies the count signal CNT indicating the count value to the memory circuit 304 in each column via the count signal line 307. The comparator 303 compares the voltage VOUT input to the first input node INP with the voltage VRAMP input to the second input node INN. Then, at a timing at which a magnitude relationship between the voltage VOUT and the voltage VRAMP has changed (for example, a point in time t108 in FIG. 5), the value of the comparison result signal COUT output from the comparator 303 changes. The memory circuit 304 holds the count value indicated by the count signal CNT supplied from the counter circuit 15 at a timing at which the value of the comparison result signal COUT has changed. At this time, the value of the count signal CNT held by the memory circuit 304 is the digital value obtained by performing the AD conversion of the noise signal. In this manner, based on a comparison result of the comparator 303, the noise signal that is one of the pixel signals is subjected to the AD conversion. Thereafter, according to the control signals from the column selection circuit 16, by sequentially operating the AD conversion circuits 21, the digital signals held in the memory circuits 304 are transferred to the output circuit 17.

At the point in time t109, the change in the voltage VRAMP in a time-dependent manner stops, and the voltage VRAMP is reset to the start voltage. The counter circuit 15 stops the counting of the clock pulse signals and then returns the count signal CNT to an initial value.

At a point in time t110, the control signal PTX1 turns to the high level from the low level, and the transfer transistor 201 of the first pixel 10-1 turns on. Then, charges accumulated in the photoelectric conversion element 200 during a predetermined exposure period are transferred to the FD 202, and the first pixel 10-1 outputs the photoelectric conversion signal to the vertical output line 20 arranged in the corresponding column as the pixel signal. At this time, the voltage of the FD 202 decreases according to the amount of charges transferred from the photoelectric conversion element 200, and the voltage VOUT also decreases.

During a period from a point in time t111 to a point in time t113, the voltage VRAMP decreases from the start voltage in a time-dependent manner. In addition, at the point in time t111, the voltage VRAMP changes, and also the counter circuit 15 starts the counting of the clock pulse signals to supply the count signal CNT indicating the count value to the memory circuit 304 in each column via the count signal line 307. The comparator 303 compares the voltage VOUT input to the first input node INP with the voltage VRAMP input to the second input node INN. Then, at a timing at which the magnitude relationship between the voltage VOUT and the voltage VRAMP has changed (for example, a point in time t112 in FIG. 5), the value of the comparison result signal COUT output from the comparator 303 changes. The memory circuit 304 holds the count value indicated by the count signal CNT supplied from the counter circuit 15 at the timing at which the value of the comparison result signal COUT has changed. At this time, the value of the count signal CNT held by the memory circuit 304 is the digital value obtained by performing the AD conversion of the photoelectric conversion signal. In this manner, based on the comparison result of the comparator 303, the photoelectric conversion signal that is one of the pixel signals is subjected to the AD conversion. Thereafter, according to the control signals from the column selection circuit 16, by sequentially operating the AD conversion circuits 21, the digital signals held in the memory circuits 304 are transferred to the output circuit 17.

In the output circuit 17, correction processing based on the correlated double sampling is applied to the thus obtained digital signals of the pixel signals. In the correction processing based on the correlated double sampling, the digitalized noise signal is subtracted from the digitalized photoelectric conversion signal to remove the noise component superimposed on the photoelectric conversion signal. In other words, a light component signal is calculated as a difference between the photoelectric conversion signal corresponding to a count value during a period from the point in time t111 to the point in time t112 and the noise signal corresponding to a count value during a period from the point in time t107 to the point in time t108.

As compared with the period T1 from a point in time to to a point in time t150, during the period T2 from the point in time t150 to a point in time t250, an amount of change in the voltage VOUT at a timing at which the control signal PTX has turned to the high level differs. Specifically, at a point in time t210, the control signal PTX2 turns to the high level from the low level, and the transfer transistor 201 of the second pixel 10-2 turns on. Then, the charges accumulated in the photoelectric conversion element 200 during the predetermined exposure period are transferred to the FD 202, and the second pixel 10-2 outputs the photoelectric conversion signal to the vertical output line 20 arranged in the corresponding column as the pixel signal. At this time, the voltage of the FD 202 decreases according to the amount of charges transferred from the photoelectric conversion element 200, and the voltage VOUT also decreases. Herein, since the amount of light incident on the second pixel 10-2 is lower than the amount of light incident on the first pixel 10-1, an amount of decrease in the voltage VOUT of the vertical output line 20 is lower than that in the first pixel 10-1. Thus, the amount of change in the voltage of the vertical output line 20 in the second pixel 10-2 is lower than that in the first pixel 10-1. It is noted that in the period T2, a count value during a period from a point in time t207 to a point in time t208 is treated as the noise signal, and a count value during a period from a point in time t211 to a point in time t212 is treated as the photoelectric conversion signal. Then, similarly as in the period T1, the light component signal that is the difference between the photoelectric conversion signal and the noise signal is calculated. It is noted that of the drive in the period T2, the drive the description of which is omitted is the same as the drive described in the period T1. By the above-described drive, the pixel signals that are the analog signals output from the first pixels 10-1 and the second pixels 10-2 with an amount of incident light different from that of the first pixel 10-1 are converted into the digital signals.

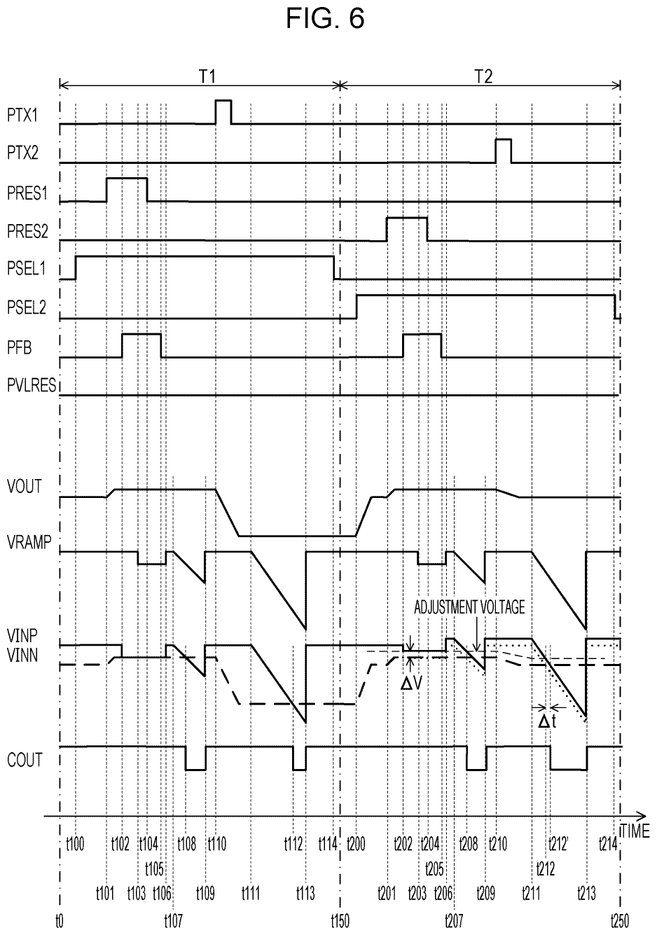

However, as illustrated in FIG. 5, in a case where the pixel signals that are output from the plurality of pixels 10 with different amounts of incident light are continuously read out, the AD conversion operation in the period T1 may affect the AD conversion operation in the period T2. This case will be described with reference to FIG. 6.

FIG. 6 is an example of the drive timing chart of the photoelectric conversion apparatus 1 according to the reference example. In FIG. 6, a horizontal axis represents time, and a vertical axis represents a voltage. In addition, FIG. 6 schematically illustrates the voltage of each of the control signals (timing of each of the drive pulses), the voltage VOUT, the voltage VRAMP, the voltage VINP at the first input node INP, and the voltage VINN at the second input node INN. It is noted that while the voltage VINP is represented by the solid line, the voltage VINN is represented by the broken line. It is noted that each of the control signals illustrated in FIG. 6 corresponds to each of the control signals illustrated in FIG. 2 and FIG. 3. It is noted that in a case where the control signal is at the high level, each of the corresponding transistors and each of the corresponding switches are put into the on state, and in a case where the control signal is at the low level, each of the corresponding transistors and each of the corresponding switches are put into the off state.

FIG. 6 illustrates timings in a case where the pixel signals are read out from the pixels 10 arranged in the first row and the second row in which the pixel signals are successively read out. It is noted that the period T1 indicates the readout period of the pixel signals output from the first pixels 10-1, and the period T2 indicates the readout period of the pixel signals output from the second pixels 10-2. The control signals PTX1, PRES1, and PSEL1 are control signals output to the first pixels 10-1, and the control signals PTX2, PRES2, and PSEL2 are control signals output to the second pixels 10-2. Herein, for example, it is assumed that the amount of light incident on the first pixel 10-1 is higher than the amount of light incident on the second pixel 10-2.

The timing of each of the drive pulses illustrated in FIG. 6 is the same as that of FIG. 5. An aspect in which the readout operation of the photoelectric conversion signal during the period T1 affects the readout operation of the photoelectric conversion signal during the period T2 will be described with reference to FIG. 6. In FIG. 6, during a period from the point in time t113 to a point in time t114 and a period from a point in time t213 to a point in time t214, the difference between the voltage VINN and the voltage VINP becomes larger than that during other periods. Furthermore, since the amount of light incident on the first pixel 10-1 is higher than the amount of light incident on the second pixel 10-2, the amount of change in the voltage VOUT during the period T1 is higher than that during the period T2. Thus, during the period from the point in time t113 to the point in time t114, the difference between the voltage VOUT and the voltage VRAMP is larger than that during the period from the point in time t213 to the point in time t214. That is, during the period from the point in time t113 to the point in time t114, the difference between the voltage VINN and the voltage VINP is larger than that during the period from the point in time t213 to the point in time t214. Thus, as the amount of incident light is higher, the difference between the voltage VINN and the voltage VINP is larger, and a period in which the difference between the voltage VINN and the voltage VINP is larger than a predetermined amount is lengthened.

In the case of the present reference example, as compared with the second input transistor 401, a period in which a potential difference between a source and a gate of the first input transistor 400 is increased is lengthened. In such a case, the variation of the threshold voltage based on the hot carrier injection due to an application of a high voltage to the first input transistor 400 occurs in the first input transistor 400. Specifically, since the carriers are trapped due to this hot carrier injection, the threshold voltage of the first input transistor 400 is increased. The drive in a case where the threshold voltage is increased is represented in a period from a point in time t202 to the point in time t213 in FIG. 6. Herein, an amount of change in the threshold voltage of the first input transistor 400 is denoted by ΔV. During a reset period of the comparator 303 from the point in time t202 to a point in time t205, the voltage VINP is increased by ΔV, and a current value flowing through the first input transistor 400 and a current value flowing through the second input transistor 401 becomes equal to each other. That is, the threshold voltage of the comparator 303 is reset to a voltage equivalent to the difference ΔV between the voltage at the reset level of the voltage VOUT and the reference voltage of the reference signal.

FIG. 6 illustrates an adjustment voltage in a case where the current value flowing through the first input transistor 400 and the current value flowing through the second input transistor 401 are adjusted to be equal to each other. It is noted that according to this adjustment voltage, the trapped carriers are emitted at and after a point in time t206 to cause the threshold voltage of the first input transistor 400 to change to a normal value, and also ΔV that is the amount of change in the threshold voltage approaches 0. In the present reference example, from the point in time t210 to the point in time t211, ΔV that is the amount of change in the threshold voltage approaches 0. It is noted that the change in the voltage VINP during a period from the point in time t202 to the point in time t250 which is illustrated in FIG. 5 is represented by a dotted line in FIG. 6.

During a period from the point in time t207 to a point in time t209 in FIG. 6, from the voltage that is higher by ΔV than the predetermined start voltage illustrated in FIG. 5, the voltage VRAMP decreases in a time-dependent manner. Then, at the point in time t208, the value of the comparison result signal COUT output from the comparator 303 changes. The memory circuit 304 holds the count value indicated by the count signal CNT supplied from the counter circuit 15 at the timing at which the value of the comparison result signal COUT has changed. At this time, the value of the count signal CNT held by the memory circuit 304 is the digital value obtained by performing the AD conversion of the noise signal. Note that since it is affected by the change in the threshold voltage of the first input transistor 400, the output of the comparator 303 is inverted at a timing at which the voltage VINP becomes the voltage higher by ΔV than the voltage VINN.

During a period from the point in time t211 to the point in time t213 in FIG. 6, from the voltage that is higher by ΔV than the predetermined start voltage illustrated in FIG. 5, the voltage VRAMP decreases in a time-dependent manner. Then, at a point in time t212′, the value of the comparison result signal COUT output from the comparator 303 changes. The memory circuit 304 holds the count value indicated by the count signal CNT supplied from the counter circuit 15 at the timing at which the value of the comparison result signal COUT has changed. At this time, the value of the count signal CNT held by the memory circuit 304 is the digital value obtained by performing the AD conversion of the photoelectric conversion signal. Note that since it is affected by the change in the threshold voltage of the first input transistor 400, the output of the comparator 303 is inverted at the timing at which the voltage VINP becomes the voltage higher by ΔV than the voltage VINN. It is noted that in this period, since the threshold voltage of the first input transistor 400 returns to the normal value, at the point in time t212′ when a magnitude relationship between the voltage VINP and the voltage VINN has changed, the value of the comparison result signal COUT output from the comparator 303 changes.

Herein, the light component signal read out from the second pixel 10-2 in a case where the change in the threshold voltage illustrated in FIG. 5 does not occur and the light component signal read out from the second pixel 10-2 in a case where the change in the threshold voltage illustrated in FIG. 6 occurs are compared with each other.

In FIG. 5, the light component signal read out from the second pixel 10-2 is calculated by using the count value corresponding to the noise signal during a period from the point in time t207 to the point in time t208 and the count value corresponding to the photoelectric conversion signal during a period from the point in time t211 to the point in time t212. That is, the light component signal is calculated by using an expression (1). Herein, the count value corresponding to the noise signal during the period from the point in time t207 to the point in time t208 is denoted by NOUT, and the count value corresponding to the photoelectric conversion signal during the period from the point in time t211 to the point in time t212 is denoted by SOUT.

$$( Light component signal ) = SOUT - NOUT \qquad ( 1 )$$

In FIG. 6, the light component signal read out from the second pixel 10-2 is calculated by using the count value corresponding to the noise signal during the period from the point in time t207 to the point in time t208 and the count value corresponding to the photoelectric conversion signal during a period from the point in time t211 to the point in time t212′. That is, the light component signal is calculated by using an expression (2). Herein, the count value corresponding to the photoelectric conversion signal during a period (Δt) from the point in time t212 to the point in time t212′ is denoted by AOUT.

$$( Light component signal ) = SOUT + ΔOUT - NOUT \qquad ( 2 )$$

By comparing the expression (1) and the expression (2) with each other, in a case where the change in the threshold voltage illustrated in FIG. 6 occurs, the light component signal to be read out from the second pixel 10-2 is read out larger than the actual light component signal by AOUT. That is, an accuracy of the AD conversion is reduced. Furthermore, a case will be considered where the amount of light incident on the first pixel 10-1 is higher than the amount of light incident on the second pixel 10-2. In this case, the light component signals read out from the second pixels 10-2 artificially increase, and an image brighter than an image that is to be originally obtained corresponding to the second pixels 10-2 is obtained, so that an image quality of the obtained image degrades.

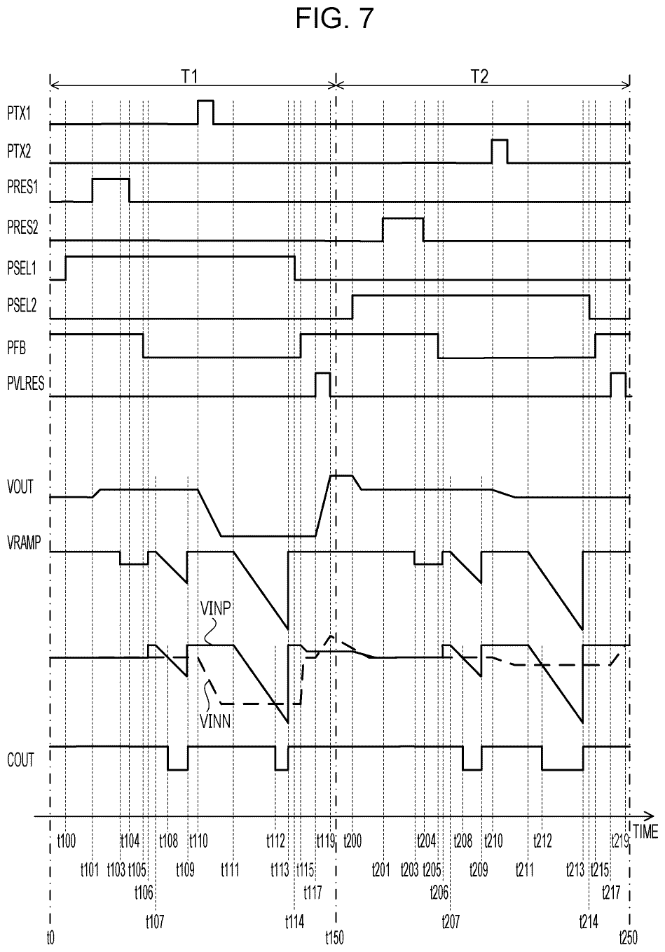

A driving method of the present embodiment for addressing the above-described issue will be described with reference to FIG. 7.

FIG. 7 is an example of the drive timing chart of the photoelectric conversion apparatus 1 according to the present embodiment. In FIG. 7, a horizontal axis represents time, and a vertical axis represents a voltage. In addition, FIG. 7 schematically illustrates the voltage of each of the control signals (timing of each of the drive pulses), the voltage VOUT, the voltage VRAMP, the voltage VINP at the first input node INP, and the voltage VINN at the second input node INN. It is noted that while the voltage VINP is represented by the solid line, the voltage VINN is represented by the broken line. It is noted that each of the control signals illustrated in FIG. 7 corresponds to each of the control signals illustrated in FIG. 2 and FIG. 3. It is noted that in a case where the control signal is at the high level, each of the corresponding transistors and each of the corresponding switches are put into the on state, and in a case where the control signal is at the low level, each of the corresponding transistors and each of the corresponding switches are put into the off state.

FIG. 7 illustrates timings in a case where the pixel signals are read out from the pixels 10 arranged in the first row and the second row in which the pixel signals are successively read out. It is noted that the period T1 indicates the readout period of the pixel signals output from the first pixels 10-1, and the period T2 indicates the readout period of the pixel signals output from the second pixels 10-2. The control signals PTX1, PRES1, and PSEL1 are control signals output to the first pixels 10-1, and the control signals PTX2, PRES2, and PSEL2 are control signals output to the second pixels 10-2. Herein, for example, it is assumed that the amount of light incident on the first pixel 10-1 is higher than the amount of light incident on the second pixel 10-2. It is noted that a difference between the driving method illustrated in FIG. 7 and the driving method illustrated in FIG. 5 and FIG. 6 resides in a driving method for the control signal PFB and the control signal PVLRES. This difference will be described by using the readout operation of the pixel signals output from the second pixels 10-2 during the period T2.

At the point in time t113, the voltage VRAMP changes to the start voltage at the point in time t111 to complete the AD conversion of the pixel signals output from the first pixels 10-1. At the point in time t114, the control signal PSEL1 turns to the low level from the high level, and the first pixels 10-1 and the vertical output line 20 are electrically separated from each other. At a point in time t115, the control signal PFB turns to the high level from the low level, and a reset operation of the comparator 303 is started. It is noted that a period from the point in time t115 to the point in time t205 in which the control signal PFB is at the high level is set as a reset period of the comparator 303. During the reset period, the control signal PVLRES turns to the high level in a period from a point in time t117 to a point in time t119. With this configuration, the first switch SW1 turns on, and the vertical output line 20 is electrically connected to the first voltage node 309. Since the control signal PVLRES turns to the high level, the voltage VINN increases at the point in time t117. At a timing at which the voltage VINN increases, the comparator 303 is in a reset state, and the comparator 303 is reset to the predetermined voltage, so that in response to the increase in the voltage VINN, the current is biased to the second input transistor 401. For this reason, the variation of the threshold voltage based on the hot carrier injection occurs in the second input transistor 401.

Specifically, since the carriers are trapped due to this hot carrier injection, the threshold voltage of the second input transistor 401 increases. As a result, the change in the threshold voltage which is to occur is substantially equal in the first input transistor 400 and the second input transistor 401, so that the first input transistor 400 and the second input transistor 401 can be regarded as substantially identical transistors. Thus, the AD conversion of the photoelectric conversion signals output from the second pixels 10-2 can be similarly performed as in a case where the variation of the threshold voltage does not occur.

According to the present embodiment, the AD conversion accuracy can be improved by the driving method illustrated in FIG. 7. It is noted that in the driving method illustrated in FIG. 7, a direction in which the voltage of the vertical output line 20 changes in a case where the pixel signal is input to the second input node INN and a direction in which the voltage of the vertical output line 20 changes in a case where the first voltage is input to the second input node INN are different from each other. Furthermore, a case is considered where the amount of light incident on the first pixel 10-1 is higher than the amount of light incident on the second pixel 10-2. In this case, the artificial increase in the light component signals read out from the second pixels 10-2 is suppressed, and an image substantially identical to the image that is to be originally obtained corresponding to the second pixels 10-2 is obtained, so that the image quality of the obtained image is improved.

### Second Embodiment

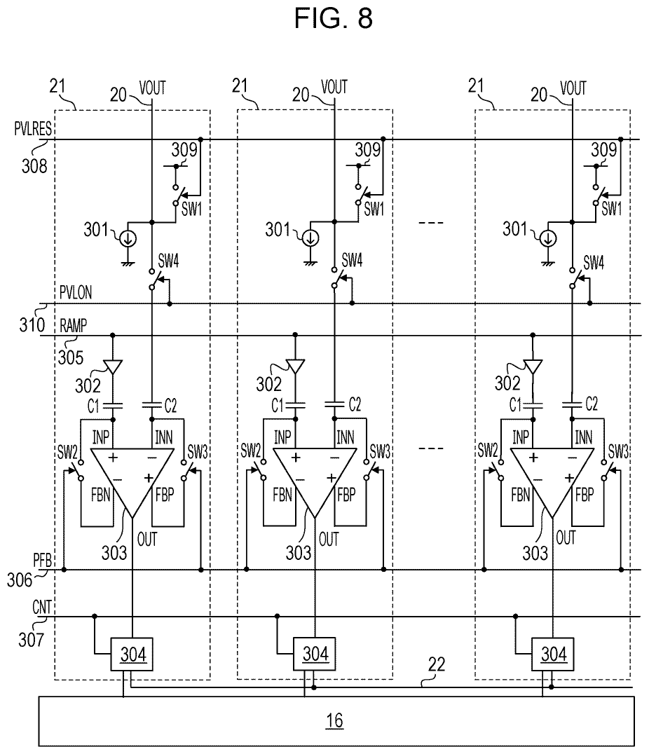

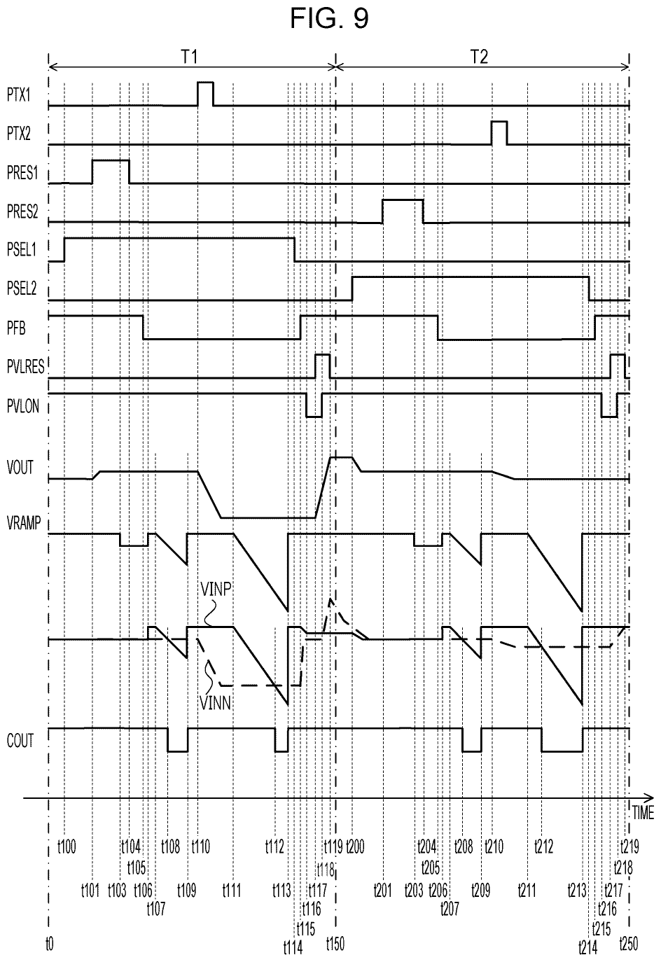

The photoelectric conversion apparatus 1 according to a second embodiment of the disclosure will be described with reference to FIG. 8 and FIG. 9. It is noted that the same reference signs are allocated to components similar to those of the first embodiment, and descriptions of these components may be omitted or simplified.

The present embodiment is different from the first embodiment in the configuration of the AD conversion circuit 21. FIG. 8 is an example of the circuit diagram of the AD conversion circuit 21 included in the photoelectric conversion apparatus 1 according to the present embodiment.

As illustrated in FIG. 8, the AD conversion circuit 21 includes a fourth switch SW4. The fourth switch SW4 is electrically connected to the second input node INN and a connection node of the vertical output line 20 and the first switch SW1. In addition, the fourth switch SW4 is arranged between the second input node INN and the connection node of the vertical output line 20 and the first switch SW1. The fourth switch SW4 is a switch controlled by a control signal PVLON supplied from the control circuit 18 via a fourth switch control line 310. When the control signal PVLON turns to the high level, the fourth switch SW4 turns on, and the connection node of the vertical output line 20 and the first switch SW1 and the node of the second capacitor element C2 on the pixel 10 side are electrically connected to each other. On the other hand, when the control signal PVLON turns to the low level, the fourth switch SW4 turns off, and the connection node of the vertical output line 20 and the first switch SW1 and the node of the second capacitor element C2 on the pixel 10 side are electrically separated from each other.

FIG. 9 is an example of the drive timing chart of the photoelectric conversion apparatus 1 according to the present embodiment. In FIG. 9, a horizontal axis represents time, and a vertical axis represents a voltage. In addition, FIG. 9 schematically illustrates the voltage of each of the control signals (timing of each of the drive pulses), the voltage VOUT, the voltage VRAMP, the voltage VINP at the first input node INP, and the voltage VINN at the second input node INN. It is noted that while the voltage VINP is represented by the solid line, the voltage VINN is represented by the broken line. It is noted that each of the control signals illustrated in FIG. 9 corresponds to each of the control signals illustrated in FIG. 2 and FIG. 8. It is noted that in a case where the control signal is at the high level, each of the corresponding transistors and each of the corresponding switches are put into the on state, and in a case where the control signal is at the low level, each of the corresponding transistors and each of the corresponding switches are put into the off state.

FIG. 9 illustrates timings in a case where the pixel signals are read out from the pixels 10 arranged in the first row and the second row in which the pixel signals are successively read out. It is noted that the period T1 indicates the readout period of the pixel signals output from the first pixels 10-1, and the period T2 indicates the readout period of the pixel signals output from the second pixels 10-2. The control signals PTX1, PRES1, and PSEL1 are control signals output to the first pixels 10-1, and the control signals PTX2, PRES2, and PSEL2 are control signals output to the second pixels 10-2. Herein, for example, it is assumed that the amount of light incident on the first pixel 10-1 is higher than the amount of light incident on the second pixel 10-2. It is noted that a difference from the first embodiment resides in that at a point in time t116 and a point in time t216, the control signal PVLON is controlled to the low level from the high level, and at a point in time t118 and a point in time t218, the control signal PVLON is controlled to the high level from the low level.

At the point in time t117 when the control signal PVLON is at the low level, similarly as in the first embodiment, the control signal PVLRES turns to the high level, and the voltage VOUT increases. Thereafter, at the point in time t118, the control signal PVLON turns to the high level from the low level, and the voltage VINN also increases. Advantages attained from this series of increase operations of the voltage VINN are similar to those of the first embodiment. Impacts caused by the change in the threshold voltage that has occurred in the first input transistor 400 can be suppressed, and the AD conversion accuracy of the pixel signals output from the second pixels 10-2 during the period T2 can be improved.

Herein, in a case where a parasitic capacitance the vertical output line 20 is large in the first embodiment, the first switch SW1 turns on, and in the drive in which the vertical output line 20 is connected to the first voltage node 309, a time constant of the voltage variation of the vertical output line 20 is increased. In a case where the time constant of the voltage variation of the vertical output line 20 is high, since the comparator 303 maintains the reset state during a period in which the first switch SW1 is turned on, a state may be established where the voltage VINN does not track the change in the voltage VOUT, and the voltage VINN does not increase to a desired voltage. According to the present embodiment, by appropriately controlling the fourth switch SW4, after the voltage VOUT is sufficiently changed, the vertical output line 20 and the node of the second capacitor element C2 on the pixel 10 side are electrically connected to each other. Thus, after the fourth switch SW4 is turned on, since it is sufficient when the second capacitor element C2 is just driven, the voltage VINN can be steeply varied, and the voltage VINN can be increased to the desired voltage.

### Third Embodiment

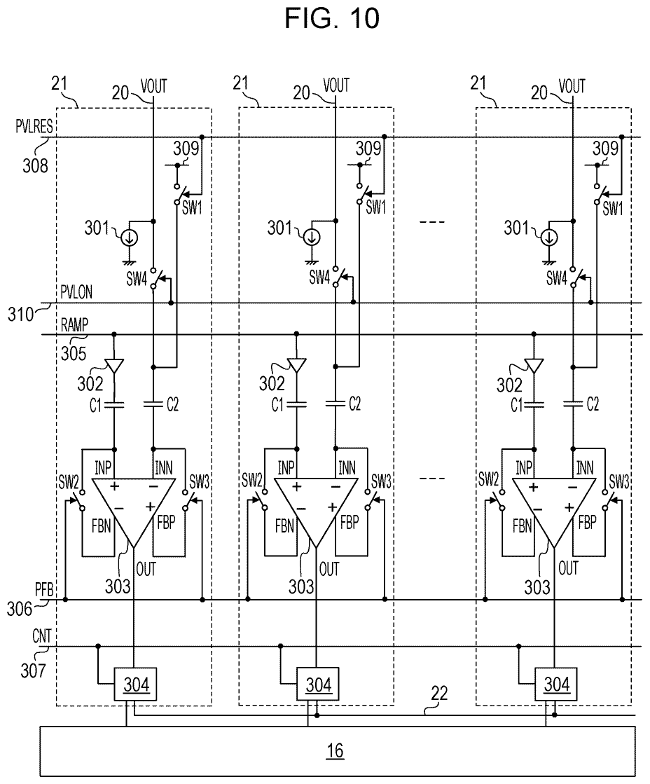

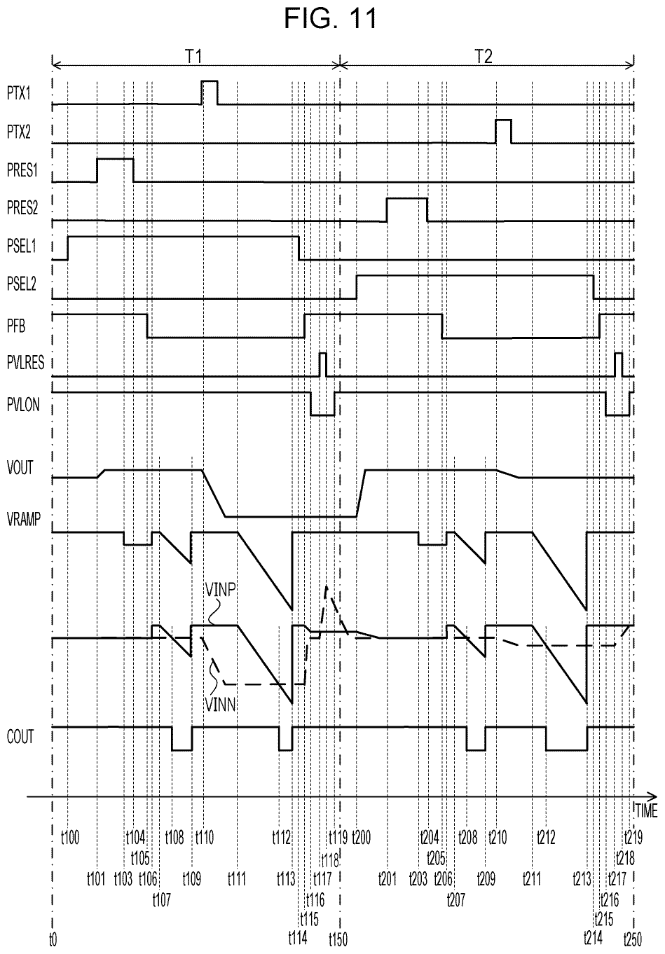

The photoelectric conversion apparatus 1 according to a third embodiment of the disclosure will be described with reference to FIG. 10 and FIG. 11. It is noted that the same reference signs are allocated to components similar to those of the first embodiment and the second embodiment, and descriptions of these components may be omitted or simplified.

The present embodiment is different from the first embodiment and the second embodiment in the configuration of the AD conversion circuit 21. FIG. 10 is an example of the circuit diagram of the AD conversion circuit 21 included in the photoelectric conversion apparatus 1 according to the present embodiment.

As illustrated in FIG. 10, the AD conversion circuit 21 includes the fourth switch SW4. The fourth switch SW4 is electrically connected to the pixel 10 and the connection node of the vertical output line 20 and the first switch SW1. In addition, the fourth switch SW4 is arranged between the pixel 10 and the connection node of the vertical output line 20 and the first switch SW1. The fourth switch SW4 is a switch controlled by the control signal PVLON supplied from the control circuit 18 via the fourth switch control line 310. When the control signal PVLON turns to the high level, the fourth switch SW4 turns on, and the pixel 10 and the connection node of the vertical output line 20 and the first switch SW1 are electrically connected to each other. On the other hand, when the control signal PVLON turns to the low level, the fourth switch SW4 turns off, and the pixel 10 and the connection node of the vertical output line 20 and the first switch SW1 are electrically separated from each other. In addition, the connection node of the vertical output line 20 and the first switch SW1 is arranged between the fourth switch SW4 and the second capacitor element C2.

FIG. 11 is an example of the drive timing chart of the photoelectric conversion apparatus 1 according to the present embodiment.

In FIG. 11, a horizontal axis represents time, and a vertical axis represents a voltage. In addition, FIG. 11 schematically illustrates the voltage of each of the control signals (timing of each of the drive pulses), the voltage VOUT, the voltage VRAMP, the voltage VINP at the first input node INP, and the voltage VINN at the second input node INN. It is noted that while the voltage VINP is represented by the solid line, the voltage VINN is represented by the broken line. It is noted that each of the control signals illustrated in FIG. 11 corresponds to each of the control signals illustrated in FIG. 2 and FIG. 10. It is noted that in a case where the control signal is at the high level, each of the corresponding transistors and each of the corresponding switches are put into the on state, and in a case where the control signal is at the low level, each of the corresponding transistors and each of the corresponding switches are put into the off state.

FIG. 11 illustrates timings in a case where the pixel signals are read out from the pixels 10 arranged in the first row and the second row in which the pixel signals are successively read out. It is noted that the period T1 indicates the readout period of the pixel signals output from the first pixels 10-1, and the period T2 indicates the readout period of the pixel signals output from the second pixels 10-2. The control signals PTX1, PRES1, and PSEL1 are control signals output to the first pixels 10-1, and the control signals PTX2, PRES2, and PSEL2 are control signals output to the second pixels 10-2. Herein, for example, it is assumed that the amount of light incident on the first pixel 10-1 is higher than the amount of light incident on the second pixel 10-2. It is noted that the drive during a period from the point in time t116 to the point in time t119 and a period from the point in time t216 to a point in time t219 is different from that of the first embodiment and the second embodiment.

At the point in time t116, the control signal PVLON turns to the low level from the high level, and the node of the second capacitor element C2 on the pixel 10 side is put into a floating state. During a period from the point in time t117 to the point in time t118, the control signal PVLRES turns to the high level, and the node of the second capacitor element C2 on the pixel 10 side is electrically connected to the first voltage node 309. Then, since the voltage VINN increases, the AD conversion accuracy of the pixel signals output from the second pixels 10-2 during the period T2 can be improved. It is noted that the drive after the control signal PVLON turns to the high level from the low level at the point in time t119 is similar to that of the second embodiment.

According to the present embodiment too, similarly as in the second embodiment, the voltage VINN can be steeply varied, and the voltage VINN can be increased to the desired voltage. Herein, according to the second embodiment, to sufficiently increase the voltage VINN, a period of time is to be used for charging a part of the vertical output line 20 arranged between the connection node of the vertical output line 20 and the first switch SW1 and the fourth switch SW4. On the other hand, according to the present embodiment, since the connection node of the vertical output line 20 and the first switch SW1 is arranged the fourth switch SW4 and the second capacitor element C2, as compared with the second embodiment, a distance of the vertical output line 20 for which the charging is demanded is shorter. Thus, according to the present embodiment, the voltage VINN can be more steeply varied, and the voltage VINN can be increased to the desired voltage in a short period of time.

### Fourth Embodiment

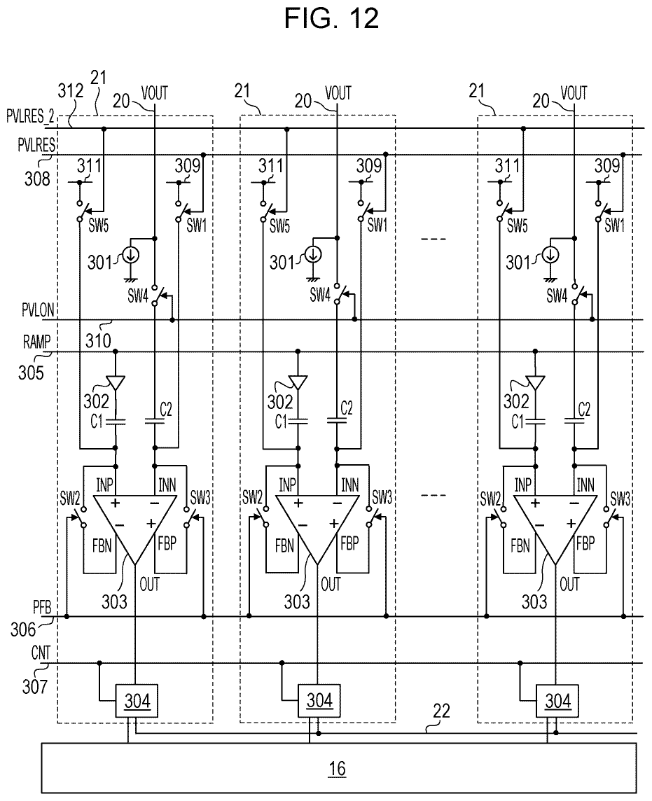

The photoelectric conversion apparatus 1 according to a fourth embodiment of the disclosure will be described with reference to FIG. 12.

It is noted that the same reference signs are allocated to components similar to those of the first embodiment, the second embodiment, and the third embodiment, and descriptions of these components may be omitted or simplified.

The present embodiment is different from the first embodiment, the second embodiment, and the third embodiment in the configuration of the AD conversion circuit 21. FIG. 12 is an example of the circuit diagram of the AD conversion circuit 21 included in the photoelectric conversion apparatus 1 according to the present embodiment.

As illustrated in FIG. 12, the AD conversion circuit 21 includes the fourth switch SW4 and a fifth switch SW5. The fourth switch SW4 is electrically connected to the pixel 10 and the node of the second capacitor element C2 on the pixel 10 side. In addition, the fourth switch SW4 is arranged between the pixel 10 and the node of the second capacitor element C2 on the pixel 10 side. The fourth switch SW4 is a switch controlled by the control signal PVLON supplied from the control circuit 18 via the fourth switch control line 310. When the control signal PVLON turns to the high level, the fourth switch SW4 turns on, and the pixel 10 and the node of the second capacitor element C2 on the pixel 10 side are electrically connected to each other. On the other hand, when the control signal PVLON turns to the low level, the fourth switch SW4 turns off, and the pixel 10 and the node of the second capacitor element C2 on the pixel 10 side are electrically separated from each other. In addition, the connection node of the vertical output line 20 and the first switch SW1 is arranged between the second capacitor element C2 and the comparator 303.

The fifth switch SW5 is electrically connected to a second voltage node 311 and the first input node INP. In addition, the fifth switch SW5 is arranged between the second voltage node 311 and the first input node INP. The fifth switch SW5 is a switch controlled by a control signal PVLON_2 supplied from the control circuit 18 via a fifth switch control line 312.

When the control signal PVLON_2 turns to the high level, the fifth switch SW5 turns on, and the second voltage node 311 and the first input node INP are electrically connected to each other. On the other hand, when the control signal PVLON turns to the low level, the fifth switch SW5 turns off, and the second voltage node 311 and the first input node INP are electrically separated from each other. The fifth switch SW5 may be controlled to be turned on or off at the same timing as the first switch SW1 or may be controlled to be regularly turned off. It is noted that the second voltage node 311 is supplied with a voltage with a voltage value substantially identical to that of the voltage supplied to the first voltage node 309.

It is noted that a configuration is adopted in which the reference signal is input to the first input node INP serving as the non-inverting input terminal of the comparator 303, and the pixel signal is input to the second input node INN serving as the inverting input terminal, but a reversed configuration may be adopted. That is, the pixel signal may be input to the first input node INP, and the reference signal may be input to the second input node INN.

According to the present embodiment too, similarly as in the first embodiment, since the voltage VINN increases, the AD conversion accuracy of the pixel signals output from the second pixels 10-2 during the period T2 can be improved.

In addition, according to the present embodiment too, similarly as in the third embodiment, the voltage VINN can be steeply varied, and the voltage VINN can be increased to the desired voltage. According to the present embodiment, as compared with the third embodiment, the distance of the vertical output line 20 for which the charging is demanded is shorter. Thus, according to the present embodiment, the voltage VINN can be more steeply varied, and the voltage VINN can be increased to the desired voltage in a short period of time.

Furthermore, according to the present embodiment, since the fifth switch SW5 is included in addition to the first switch SW1, parasitic capacitances can be set to be substantially equal between the first input node INP and the second input node INN, and the AD conversion accuracy can be improved.

### Fifth Embodiment

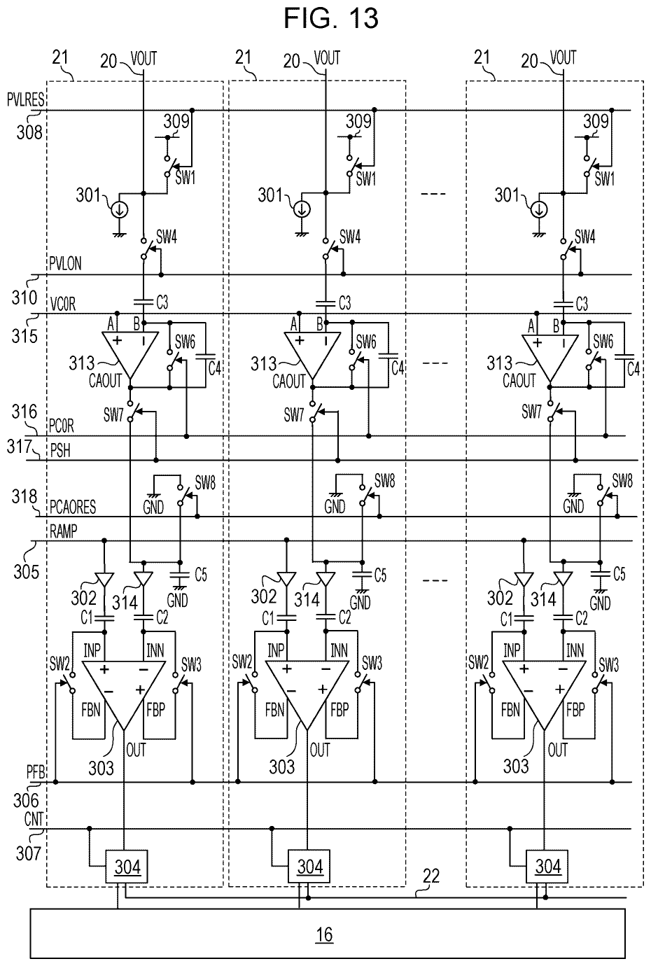

The photoelectric conversion apparatus 1 according to a fifth embodiment of the disclosure will be described with reference to FIG. 13 to FIG. 15. It is noted that the same reference signs are allocated to components similar to those of the first embodiment, the second embodiment, the third embodiment, and the fourth embodiment, and descriptions of these components may be omitted or simplified.

The present embodiment is different from the first embodiment, the second embodiment, the third embodiment, and the fourth embodiment in the configuration of the AD conversion circuit 21. FIG. 13 is an example of the circuit diagram of the AD conversion circuit 21 included in the photoelectric conversion apparatus 1 according to the present embodiment.

As illustrated in FIG. 13, the AD conversion circuit 21 includes an amplifier 313, a second buffer circuit 314, a third capacitor element C3, a fourth capacitor element C4, a fifth capacitor element C5, a sixth switch SW6, a seventh switch SW7, and an eighth switch SW8. Between the pixel 10 and the comparator 303, the fourth switch SW4, the third capacitor element C3, the amplifier 313, the seventh switch SW7, the second buffer circuit 314, and the second capacitor element C2 are arranged in the stated order, and those components are mutually electrically connected.

The amplifier 313 includes a third input node A serving as a non-inverting input terminal, a fourth input node B serving as an inverting input terminal, and an output node CAOUT. The vertical output line 20 is electrically connected to the fourth input node B via the third capacitor element C3. The pixel signal output from the pixel 10 is input to the fourth input node B via the vertical output line 20 and the third capacitor element C3. A voltage VCOR output from the control circuit 18 is input to the third input node A. The fourth capacitor element C4 is electrically connected to the output node CAOUT and the fourth input node B and arranged between the output node CAOUT and the fourth input node B. The amplifier 313 multiplies the input pixel signal by a gain of (C3/C4) times (amplified by a factor of (C3/C4)) to output the pixel signal. It is noted that in the present specification, a voltage of the output node CAOUT of the amplifier 313 may be denoted by VCAOUT.

The sixth switch SW6 is electrically connected to the output node CAOUT and the fourth input node B and arranged between the output node CAOUT and the fourth input node B. The sixth switch SW6 is a switch controlled by a control signal PCOR supplied from the control circuit 18 via a sixth switch control line 316. Since the control signal PCOR turns to the high level, the amplifier 313 is reset.

The second buffer circuit 314 includes an input node and an output node. The input node of the second buffer circuit 314 is supplied with the pixel signal from the pixel 10 via the amplifier 313. The output node of the second buffer circuit 314 is electrically connected to the second input node INN via the second capacitor element C2. That is, the pixel signal output from the pixel 10 is input to the second input node INN via the amplifier 313, the second buffer circuit 314, and the second capacitor element C2.

The seventh switch SW7 is electrically connected to the output node CAOUT and the input node of the second buffer circuit 314 and arranged between the output node CAOUT and the input node of the second buffer circuit 314. The seventh switch SW7 is a switch controlled by a control signal PSH supplied from the control circuit 18 via a seventh switch control line 317.

The eighth switch SW8 is electrically connected to the input node of the second buffer circuit 314 and the ground voltage node GND and arranged between the input node of the second buffer circuit 314 and the ground voltage node GND. The eighth switch SW8 is a switch controlled by a control signal PCAORES supplied from the control circuit 18 via an eighth switch control line 318. Since the control signal PCAORES turns to the high level, the input node of the second buffer circuit 314 is electrically connected to the ground voltage node GND.

The fifth capacitor element C5 is electrically connected to the input node of the second buffer circuit 314 and the ground voltage node GND and arranged between the input node of the second buffer circuit 314 and the ground voltage node GND.

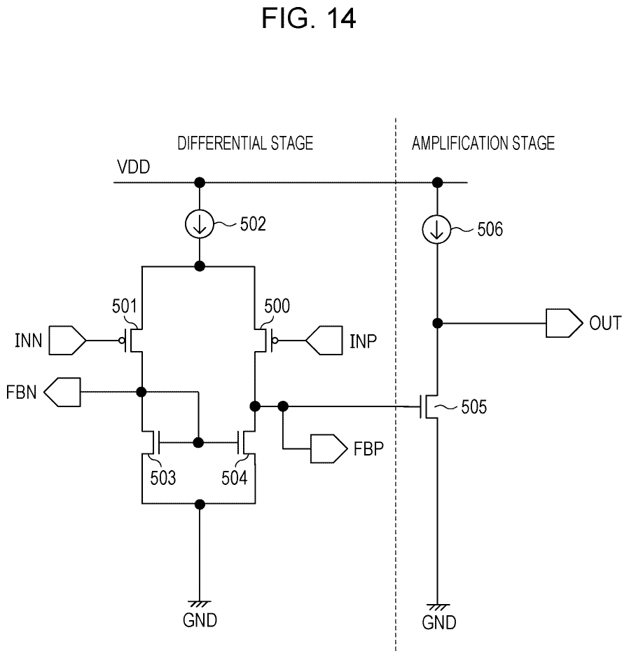

FIG. 14 is an example of the circuit diagram of the comparator 303 included in the AD conversion circuit 21 according to the present embodiment.

As illustrated in FIG. 14, the comparator 303 includes a differential stage and an amplification stage. In the differential stage, a fourth input transistor 500, a fifth input transistor 501, a third current source 502, a third current mirror transistor 503, and a fourth current mirror transistor 504 are arranged. The fourth input transistor 500 is arranged so as to correspond to the third input node A, and the fifth input transistor 501 is arranged so as to correspond to the fourth input node B. In the amplification stage, a sixth input transistor 505 and a fourth current source 506 are arranged.

The comparator 303 described in FIG. 4 includes the first input transistor 400, the second input transistor 401, and the third input transistor 405, and these transistors are constituted by MOS transistors of the N type. In addition, the comparator 303 described in FIG. 4 includes the first current mirror transistor 403 and the second current mirror transistor 404, and these transistors are constituted by MOS transistors of the P type. On the other hand, the comparator 303 of the present embodiment described in FIG. 14 includes the fourth input transistor 500, the fifth input transistor 501, and the sixth input transistor 505, and these transistors are constituted by MOS transistors of the P type. In addition, the comparator 303 of the present embodiment described in FIG. 14 includes the third current mirror transistor 503 and the fourth current mirror transistor 504, and these transistors are constituted by MOS transistors of the N type.

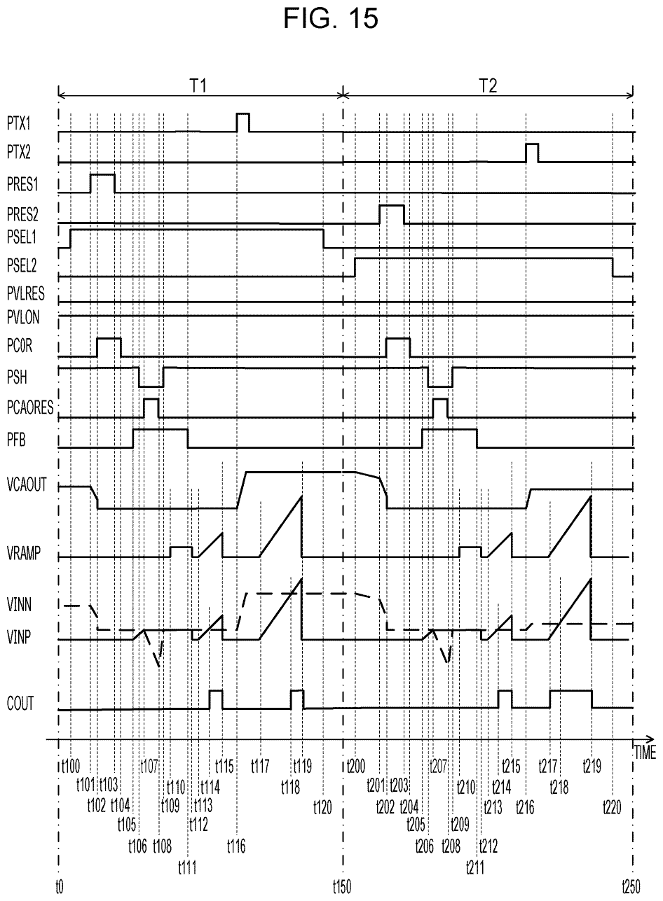

FIG. 15 is an example of the drive timing chart of the photoelectric conversion apparatus 1 according to the present embodiment.

In FIG. 15, a horizontal axis represents time, and a vertical axis represents a voltage. In addition, FIG. 15 schematically illustrates the voltage of each of the control signals (timing of each of the drive pulses), a voltage VCAOUT, the voltage VRAMP, the voltage VINP at the first input node INP, and the voltage VINN at the second input node INN. It is noted that while the voltage VINP is represented by the solid line, the voltage VINN is represented by the broken line. It is noted that each of the control signals illustrated in FIG. 15 corresponds to each of the control signals illustrated in FIG. 2 and FIG. 13. It is noted that in a case where the control signal is at the high level, each of the corresponding transistors and each of the corresponding switches are put into the on state, and in a case where the control signal is at the low level, each of the corresponding transistors and each of the corresponding switches are put into the off state. It is noted that in FIG. 15, the control signal PVLRES is regularly at the low level, and the control signal PVLON is regularly at the high level.

FIG. 15 illustrates timings in a case where the pixel signals are read out from the pixels 10 arranged in the first row and the second row in which the pixel signals are successively read out. It is noted that the period T1 indicates the readout period of the pixel signals output from the first pixels 10-1, and the period T2 indicates the readout period of the pixel signals output from the second pixels 10-2. The control signals PTX1, PRES1, and PSEL1 are control signals output to the first pixels 10-1, and the control signals PTX2, PRES2, and PSEL2 are control signals output to the second pixels 10-2. Herein, for example, it is assumed that the amount of light incident on the first pixel 10-1 is higher than the amount of light incident on the second pixel 10-2.

At the point in time t100, the control signal PSEL1 turns to the high level from the low level, and the selection transistor 204 of the first pixel 10-1 turns on. Then, the first row is selected as a row from which the pixel signals are to be output.

During a period from the point in time t101 to the point in time t103, the control signal PRES1 turns to the high level, and the reset transistor 205 of the first pixel 10-1 turns on. Then, the first pixel 10-1 outputs the noise signal to the vertical output line 20 arranged in the corresponding column as the pixel signal.

During a period from the point in time t102 to the point in time t104, the control signal PCOR turns to the high level, and the fourth switch SW4 turns on. Then, the amplifier 313 is put into the reset state, and the fourth input node B serving as the inverting input terminal is reset to the voltage VCOR.

During a period from the point in time t105 to the point in time t111, the control signal PFB turns to the high level, and the second switch SW2 and the third switch SW3 turn on. Then, the first input node INP and the second input node INN of the comparator 303 are reset to the voltage at the reset level. It is noted that at the point in time t110, the voltage VRAMP turns to the reference voltage, and the offset removal operation is performed.

At the point in time t112, the voltage VRAMP decreases to the predetermined start voltage from the reference voltage.

Next, during a period from the point in time t113 to the point in time t115, the voltage VRAMP increases from the start voltage in a time-dependent manner. It is noted that according to the present embodiment, since the amplifier 313 is an inverting amplifier, a polarity of an output amplitude of the pixel signal input to the comparator 303 via the amplifier 313 is different from that of the first embodiment to the fourth embodiment. For this reason, as illustrated in FIG. 15, the present embodiment is different from the first embodiment to the fourth embodiment in that the voltage VRAMP is controlled to increase from the start voltage in a time-dependent manner.

A further difference of the present embodiment from the above-described embodiments other than the different polarity of the output amplitude described above will be described below. According to the present embodiment, the drive during a period from the point in time t106 to the point in time t109 and the drive during a period from the point in time t206 to the point in time t209 are different from those of the above-described embodiments. Herein, the drive during the period from the point in time t206 to the point in time t209 will be described as a representative example.

In FIG. 15, during a period from the point in time t119 to a point in time t120 and a period from a point in time t219 to a point in time t220, the difference between the voltage VINN and the voltage VINP becomes larger than that during other periods. Furthermore, since the amount of light incident on the first pixel 10-1 is higher than the amount of light incident on the second pixel 10-2, the amount of change in the voltage VOUT during the period T1 is higher than that during the period T2. Thus, during the period from the point in time t119 to the point in time t120, the difference between the voltage VOUT and the voltage VRAMP is larger than that during the period from the point in time t219 and the point in time t220. That is, during the period from the point in time t119 to the point in time t120, the difference between the voltage VINN and the voltage VINP is larger than that during the period from the point in time t219 and the point in time t220. Thus, as the amount of incident light is higher, the difference between the voltage VINN and the voltage VINP is larger, and the period in which the difference between the voltage VINN and the voltage VINP is larger than the predetermined amount is lengthened.

According to the present embodiment, as compared with the fifth input transistor 501, a period in which a potential difference between a source and a gate of the fourth input transistor 500 is increased is longer. In such a case, the variation of the threshold voltage based on the hot carrier injection occurs in the fourth input transistor 500 due to the application of the high voltage to the fourth input transistor 500. Specifically, since the carriers are trapped due to this hot carrier injection, the threshold voltage of the fourth input transistor 500 is increased. Then, since the threshold of the fourth input transistor 500 included in the comparator 303 changes, as described in the explanation of the first embodiment, the AD conversion accuracy degrades.

According to the present embodiment, at the point in time t205, the control signal PFB turns to the high level from the low level, and the reset operation of the comparator 303 is started. It is noted that a period from the point in time t205 to the point in time t211 in which the control signal PFB is at the high level is set as the reset period of the comparator 303. In addition, during a period from the point in time t206 to the point in time t209, the control signal PSH turns to the low level, and the amplifier 313 and the comparator 303 are put into the non-conductive state. Furthermore, during a period from the point in time t207 to the point in time t208, the control signal PCAORES turns to the high level. With this configuration, the eighth switch SW8 turns on, and the second input node INN is electrically connected to the ground voltage node GND via the second capacitor element C2 and the second buffer circuit 314. Since the control signal PCAORES turns to the high level, the voltage VINN decreases at the point in time t207. At a timing at which the voltage VINN decreases, the comparator 303 is in the reset state, and the comparator 303 is reset to the predetermined voltage, so that in response to the decrease in the voltage VINN, the current is biased to the fifth input transistor 501. For this reason, the variation of the threshold voltage based on the hot carrier injection occurs in the fifth input transistor 501. Specifically, since the carriers are trapped due to this hot carrier injection, the threshold voltage of the fifth input transistor 501 increases. As a result, the change in the threshold voltage that is to occur in the fourth input transistor 500 and the fifth input transistor 501 are substantially identical to each other, and the fourth input transistor 500 and the fifth input transistor 501 can be regarded as substantially identical transistors. Thus, the AD conversion of the photoelectric conversion signals output from the second pixels 10-2 can be similarly preformed as in a case where the variation of the threshold voltage does not occur.

According to the present embodiment, the AD conversion accuracy can be improved by the drive illustrated in FIG. 15. Furthermore, a case will be considered where the amount of light incident on the first pixel 10-1 is higher than the amount of light incident on the second pixel 10-2. In this case, the artificial increase in the light component signals read out from the second pixels 10-2 is suppressed, and an image substantially identical to the image that is to be originally obtained corresponding to the second pixel 10-2 is obtained, so that the image quality of the obtained image is improved.

### Sixth Embodiment

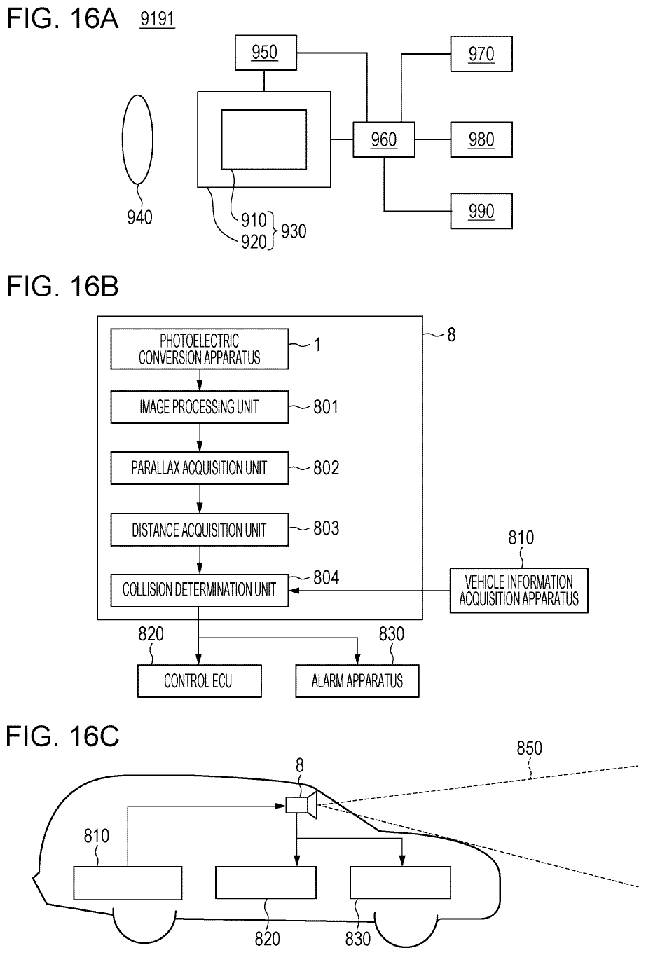

A sixth embodiment can be applied to any of the first embodiment to the fifth embodiment. FIG. 16A is a schematic diagram for describing an equipment 9191 including a semiconductor apparatus 930 of the present embodiment. The photoelectric conversion apparatus of each of the above-mentioned embodiments can be used as the semiconductor apparatus 930. The equipment 9191 including the semiconductor apparatus 930 will be described in detail. The semiconductor apparatus 930 can include a semiconductor device 910. The semiconductor apparatus 930 can include, in addition to the semiconductor device 910, a package 920 that accommodates the semiconductor device 910. The package 920 can include a base to which the semiconductor device 910 is fixed and a lid such as glass facing the semiconductor device 910. The package 920 can further include a bonding member such as a bonding wire or a bump that connects a terminal provided in the base and a terminal provided in the semiconductor device 910.

The equipment 9191 may include at least any of an optical apparatus 940, a control apparatus 950, a processing apparatus 960, a display apparatus 970, a storage device 980, and a mechanical apparatus 990. The optical apparatus 940 corresponds to the semiconductor apparatus 930. The optical apparatus 940 is, for example, a lens, a shutter, or a mirror and includes an optical system configured to guide light to the semiconductor apparatus 930. The control apparatus 950 controls the semiconductor apparatus 930. The control apparatus 950 is, for example, a semiconductor apparatus such as an application specific integrated circuit (ASIC).

The processing apparatus 960 processes a signal output from the semiconductor apparatus 930. The processing apparatus 960 is a semiconductor apparatus such as a central processing unit (CPU) or an ASIC that constitutes an analog front end (AFE) or a digital front end (DFE). The display apparatus 970 is an electro-luminescence (EL) display apparatus or a liquid crystal display apparatus configured to display information (image) acquired by the semiconductor apparatus 930. The storage device 980 is a magnetic device or a semiconductor device configured to store the information (image) acquired by the semiconductor apparatus 930. The storage device 980 is a volatile memory such as a static random access memory (SRAM) or a dynamic random access memory (DRAM), or a non-volatile memory such as a flash memory or a hard disk drive.

The mechanical apparatus 990 includes a movable part or a propulsive part such as a motor or an engine. In the equipment 9191, the signal output from the semiconductor apparatus 930 is displayed on the display apparatus 970 or transmitted to the outside by a communication apparatus (not illustrated) included in the equipment 9191. For this reason, in one embodiment, the equipment 9191 further includes the storage device 980 or the processing apparatus 960 in addition to a storage circuit or an arithmetic operation circuit included in the semiconductor apparatus 930. The mechanical apparatus 990 may be controlled based on the signal output from the semiconductor apparatus 930.

The equipment 9191 is also appropriately used as electronic equipment such as an information terminal (for example, a smartphone or a wearable terminal) having a shooting function or a camera (for example, an interchangeable lens camera, a compact camera, a video camera, or a surveillance camera). The mechanical apparatus 990 in the camera can drive parts of the optical apparatus 940 for zooming, focusing, and a shutter operation. Alternatively, the mechanical apparatus 990 in the camera can move the semiconductor apparatus 930 for an image stabilization operation.

In addition, the equipment 9191 may be transportation equipment such as a vehicle, a ship, or a flying object (such as a drone or an aircraft). The mechanical apparatus 990 in the transportation equipment may be used as a transportation apparatus. The equipment 9191 serving as the transportation equipment is appropriately used as a component configured to transport the semiconductor apparatus 930 or a component configured to assist and/or automate driving (piloting) by the shooting function. The processing apparatus 960 configured to assist and/or automate driving (piloting) can perform processing to operate the mechanical apparatus 990 serving as the transportation apparatus based on the information acquired by the semiconductor apparatus 930. Alternatively, the equipment 9191 may be medical equipment such as an endoscope, measuring equipment such as a distance measuring sensor, analytical equipment such as an electron microscope, office equipment such as a copier, or industrial equipment such as a robot.

According to the above-described embodiment, it becomes possible to attain a satisfactory pixel characteristic. Therefore, a value of the semiconductor apparatus can be increased. For the increase in the value mentioned herein, at least any of an addition of a function, an improvement of a performance, an improvement of a characteristic, an improvement of a reliability, an improvement of a manufacturing yield, a reduction of an environmental impact, a cost reduction, a size reduction, and a weight reduction applies.

Therefore, when the semiconductor apparatus 930 according to the present embodiment is used as the equipment 9191, the value of the equipment can also be improved. For example, by mounting the semiconductor apparatus 930 to the transportation equipment, it is possible to attain an excellent performance when an outside of the transportation equipment is shot or an external environment is measured. Thus, when the transportation equipment is to be manufactured and to be on sale, a decision of mounting the semiconductor apparatus according to the present embodiment to the transportation equipment is advantageous in an improvement of the performance of the transportation equipment itself. In particular, the semiconductor apparatus 930 is appropriately used as the transportation equipment configured to perform driving assistance and/or automated driving of the transportation equipment by using the information acquired by the semiconductor apparatus.

A photoelectric conversion system and a moving object of the present embodiment will be described with reference to FIGS. 16B and 16C.

FIG. 16B is an example of a photoelectric conversion system related to an on-vehicle camera. A photoelectric conversion system 8 includes the photoelectric conversion apparatus 1. The photoelectric conversion apparatus 1 is the photoelectric conversion apparatus (image sensing apparatus) described in any of the above-described embodiments. The photoelectric conversion system 8 includes an image processing unit 801 configured to perform image processing on a plurality of pieces of image data acquired by the photoelectric conversion apparatus 1 and a parallax acquisition unit 802 configured to calculate a parallax (phase difference of parallax images) from a plurality of pieces of image data acquired by the photoelectric conversion system 8. The photoelectric conversion system 8 herein may also include, for example, an optical system (not illustrated) configured to guide light to the photoelectric conversion apparatus 1 such as the lens, the shutter, or the mirror. In addition, a plurality of photoelectric conversion units that are substantially conjugate with a pupil of the optical system may be arranged for pixels included in the photoelectric conversion apparatus 1. For example, the plurality of photoelectric conversion units that are substantially conjugate with the pupil are arranged so as to correspond to a single microlens. When the plurality of photoelectric conversion units receive light beams that have transmitted through mutually different positions of the pupil of the optical system, the photoelectric conversion apparatus 1 outputs image data corresponding to the light beams that have transmitted through the different positions. Then, the parallax acquisition unit 802 may calculate the parallax by using the output image data. In addition, the photoelectric conversion system 8 includes a distance acquisition unit 803 configured to calculate a distance to a target object based on the calculated parallax and a collision determination unit 804 configured to determine whether or not there is a possibility of collision based on the calculated distance. Herein, the parallax acquisition unit 802 and the distance acquisition unit 803 are examples of a distance information acquisition unit configured to acquire distance information of a distance to the target object. That is, the distance information refers to information related to a parallax, a defocus amount, a distance to the target object, or the like. The collision determination unit 804 may determine the possibility of collision by using any of these pieces of distance information. It is noted that the distance information may be acquired based on time of flight (ToF). The distance information acquisition unit may be realized by specifically designed hardware or may be realized by a software module. In addition, the distance information acquisition unit may be realized by a field programmable gate array (FPGA), an application specific integrated circuit (ASIC), or the like or may be realized by a combination of these components.

The photoelectric conversion system 8 is connected to a vehicle information acquisition apparatus 810 and can acquire vehicle information such as a vehicle speed, a yaw rate, or a steering angle. The photoelectric conversion system 8 is also connected to a control electronic control unit (ECU) 820 serving as a control apparatus configured to output a control signal for generating a braking force for the vehicle based on a result of the determination in the collision determination unit 804. The photoelectric conversion system 8 is also connected to an alarm apparatus 830 configured to issue an alarm to a driver based on a result of the determination in the collision determination unit 804. For example, in a case where the possibility of collision is high as the determination result of the collision determination unit 804, the control ECU 820 performs vehicle control to avoid a collision or mitigate damage by applying a brake, releasing an accelerator, reducing an engine output, or the like. The alarm apparatus 830 warns a user by sounding an alarm such as a sound, displaying alarm information on a screen such as a car navigation system, applying vibration to a seat belt or a steering wheel, or the like.

According to the present embodiment, an image of a surrounding of the vehicle, for example, a front area or a rear area is to be sensed by the photoelectric conversion system 8.

FIG. 16C illustrates the photoelectric conversion system 8 in a case where an image of the front area of the vehicle (image sensing area 850) is to be sensed. The vehicle information acquisition apparatus 810 transmits an instruction to the photoelectric conversion system 8 or the photoelectric conversion apparatus 1. With such a configuration, an accuracy of the distance measurement can be further improved.

In the above, the example of the control to avoid the collision with other vehicles has been described, but the embodiment can be applied to control for autonomous drive by following other vehicles, control for autonomous drive so as not to stray from its lane, or the like. Furthermore, the photoelectric conversion system 8 can be applied to not only a vehicle such as an automobile but also a moving object (mobile apparatus) such as, for example, a ship, aircraft, or an industrial robot. This moving object includes either or both of a drive force generation unit configured to generate a drive force to be mainly used for movement of the moving object and a rotating body to be mainly used for movement of the moving object. The drive force generation unit may be an engine, a motor, or the like. The rotating body may be a tire, a wheel, a screw of a vessel, a propeller of a flying vehicle. Moreover, the embodiment can be applied to not only the moving object but also an equipment that widely uses object recognition such as intelligent transport systems (ITS).

In the present specification, expressions “A or B”, “at least one of A and B”, “at least one of A or/and B”, and “one or more of A or/and B” contain all possible combinations of enumerated items unless otherwise explicitly defined. That is, the above expressions are to be understood to disclose all of the following cases including a case where at least one A is included, a case where at least one B is included, and a case where at least one A and at least one B are both included. The same also applies to a combination of three or more elements.

The embodiments described above can be modified as appropriate in a scope without departing from the technical concept. It is noted that the content disclosed in the present specification is not limited to described configurations in the present specification but also includes all matters that can be understood from the present specification and the accompanying drawings of the present specification. The content disclosed in the present specification also includes a complement set of concepts described in the present specification. That is, when a phrase “A is larger than B” is stated in the present specification, for example, even when a phrase “A is not larger than B” is omitted, it can be construed that the present specification discloses a notion that “A is not larger than B”. This is because in a case where the phrase “A is larger than B” is stated, it is assumed that a case where “A is not larger than B” is taken into consideration.

According to each of the embodiments of the disclosure, it is possible to provide the photoelectric conversion apparatus with the improved AD conversion accuracy.

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-074089, filed Apr. 30, 2024, which is hereby incorporated by reference herein in its entirety.

What is claimed is:

1. A method for a conversion apparatus including
a pixel configured to generate a pixel signal through photoelectric conversion,
an output line connectable to the pixel, and
a comparator including a first input node to which a reference signal is input and a second input node to which the pixel signal is input via the output line,
the method comprising:
causing a voltage of the second input node to change from a second voltage to a first voltage and thereafter change from the first voltage to a third voltage during a reset period of the comparator;
causing the voltage of the second input node to change in a first direction in a case where the pixel signal is input to the second input node; and
setting a direction in which the voltage of the second input node changes from the second voltage to the first voltage to be different from the first direction and setting a direction in which the voltage of the second input node changes from the first voltage to the third voltage to be the same as the first direction.

2. The method according to claim 1, wherein the pixel includes a plurality of pixels arranged in a plurality of rows, the pixels include a first pixel arranged in a first row and a second pixel arranged in a second row, and the comparator is reset during a period from a timing at which the pixel signal is output from the first pixel to a timing at which the pixel signal is output from the second pixel.

3. The method according to claim 1, wherein the comparator includes a first transistor corresponding to the first input node and a second transistor corresponding to the second input node, and during the reset period of the comparator, a threshold voltage of the second transistor changes when the first voltage is input to the second input node.

4. The method for the according to claim 3, wherein a threshold voltage of the first transistor changes when the pixel signal is input to the second input node, and an amount of change in the threshold voltage of the first transistor and an amount of change in the threshold voltage of the second transistor are substantially equal to each other.

5. The method according to claim 1, wherein
the conversion apparatus includes a capacitor element connected between the output line and the second input node, and
the first voltage is input to the second input node via the capacitor element during the reset period of the comparator.

6. The method according to claim 1, wherein
the conversion apparatus includes a first voltage node which is connectable to the output line and to which the first voltage is supplied, and a first switch arranged between the first voltage node and the output line, and
the first switch is controlled to be ON from OFF during the reset period of the comparator.

7. The method according to claim 6, wherein
the first switch includes a first node connected to the first voltage node and a second node connected to the output line, and the conversion apparatus includes a fourth switch arranged between the second node and the comparator, and
the first switch is controlled to be ON from OFF during a period in which the fourth switch is OFF.

8. The method according to claim 6, wherein
the first switch includes a first node connected to the first voltage node and a second node connected to the output line, and the conversion apparatus includes a fourth switch arranged between the second node and the pixel, and
the first switch is controlled to be ON from OFF during a period in which the fourth switch is OFF.

9. The method according to claim 6, wherein
the conversion apparatus includes a second voltage node connectable to the first input node, and a fifth switch arranged between the second voltage node and the first input node, and
the fifth switch is controlled to be ON from OFF at substantially the same timing as the first switch.

10. The method apparatus according to claim 1, wherein the conversion apparatus includes an amplifier arranged between the pixel and the comparator, and the amplifier amplifies the pixel signal.

11. The method apparatus according to claim 1, wherein the comparator includes a second switch and a third switch which are configured to reset a threshold voltage of the comparator, and the comparator is reset when the second switch and the third switch turn ON.

12. The method according to claim 1, wherein the first voltage is a power source voltage.

13. The method according to claim 1, wherein the comparator performs analog-to-digital conversion of the pixel signal by comparing the pixel signal and the reference signal with each other.

14. A conversion apparatus comprising:
a pixel configured to generate a pixel signal through photoelectric conversion;
an output line connectable to the pixel;
a comparator including a first input node to which a reference signal is input and a second input node to which the pixel signal is input via the output line;
a first switch arranged between a first voltage node and the output line; and
a control circuit configured to control the first switch,
wherein the control circuit controls the first switch to be ON from OFF during a reset period of the comparator.

15. The conversion apparatus according to claim 14, wherein
a voltage of the second input node changes from a second voltage to a first voltage and thereafter changes from the first voltage to a third voltage during the reset period of the comparator,
the voltage of the second input node changes in a first direction in a case where the pixel signal is input to the second input node, and
a direction in which the voltage of the second input node changes from the second voltage to the first voltage is different from the first direction, and a direction in which the voltage of the second input node changes from the first voltage to the third voltage is the same as the first direction.

16. The conversion apparatus according to claim 14, wherein
the comparator includes a first transistor corresponding to the first input node and a second transistor corresponding to the second input node, and during the reset period of the comparator, a threshold voltage of the second transistor changes when the first voltage is input to the second input node from the first voltage node.

17. The conversion apparatus according to claim 16, wherein
a threshold voltage of the first transistor changes when the pixel signal is input to the second input node, and an amount of change in the threshold voltage of the first transistor and an amount of change in the threshold voltage of the second transistor are substantially equal to each other.

18. An equipment comprising the conversion apparatus according to claim 14, wherein the equipment further comprises at least any of
an optical apparatus configured to guide light to the conversion apparatus,
a control apparatus configured to control the conversion apparatus,
a processing apparatus configured to process a signal output from the conversion apparatus,
a display apparatus configured to display information acquired in the conversion apparatus,
a storage device configured to store information acquired in the conversion apparatus, and
a mechanical apparatus arranged to operate based on information acquired in the conversion apparatus.

19. The equipment according to claim 18, wherein, in the conversion apparatus,
a voltage of the second input node changes from a second voltage to a first voltage and thereafter changes from the first voltage to a third voltage during the reset period of the comparator,
the voltage of the second input node changes in a first direction in a case where the pixel signal is input to the second input node, and
a direction in which the voltage of the second input node changes from the second voltage to the first voltage is different from the first direction, and a direction in which the voltage of the second input node changes from the first voltage to the third voltage is the same as the first direction.

20. The equipment according to claim 18, wherein, in the conversion apparatus,
the comparator includes a first transistor corresponding to the first input node and a second transistor corresponding to the second input node, and during the reset period of the comparator, a threshold voltage of the second transistor changes when the first voltage is input to the second input node from the first voltage node.
